(19) United States
(12) Patent Application Publication
(10) Pub. No.: US 2012/0029948 A1
(43) Pub. Date: Feb. 2, 2012

(54) Method And System For Determining Rate Of Insurance

(75) Inventors: James Keenan Prendergast, Wooside, NY (US); James Kenneth Mangold, Bayside, NY (US)

(73) Assignee: American International Group, New York, NY (US)

(21) Appl. No.: 13/189,227

(22) Filed: Jul. 22, 2011

Related U.S. Application Data
(62) Division of application No. 11/944,241, filed on Nov. 21, 2007.
(60) Provisional application No. 60/860,365, filed on Nov. 21, 2006.

(51) Int. Cl. G06Q 40/00

(52) U.S. Cl. 705/4

(57) ABSTRACT

A method and system for determining a rate of insurance for management liability coverage which determines a base premium, a limit/retention factor, shared limit credits, and other rating considerations. The limit/retention factor, shared limit credits, and rating considerations are applied to the base premium to ascertain a resultant premium. Another aspect of the disclosure provides a method for determining a shared limit credit when insured clients purchase multiple insurance coverages in a single policy or package of policies and subject to common limit of liability.

### CROSS-REFERENCE TO RELATED APPLICATIONS

This patent application is a divisional of co-pending U.S. patent application Ser. No. 11/944,241, filed Nov. 21, 2007, which claims the benefit of U.S. Provisional Patent Application No. 60/860,365, filed Nov. 21, 2006, both of which are incorporated by reference herein in their entireties for all that they teach, including without limitation all drawing figures therein.

### TECHNICAL FIELD

The disclosure generally relates to determining insurance risk and rates. More particularly, the disclosure relates to determining insurance rates for management liability insurance, such as directors and officers liability insurance.

### BACKGROUND

Director and officers of publicly traded corporations and other organizations bear certain risks of liability. For example, directors bear a risk of liability to shareholders for failure to discharge their fiduciary duties or violations of securities laws or other laws. Corporate officers and/or directors may be subject to liability for a host of occurrences. For example, they risk liability due to lack of management supervision, inaccuracy in statements of financial accounts, lack of judgment and good faith, mismanagement of funds, incorrect statements in prospectuses, allotment of shares, unauthorized loans or investments, failure to obtain competitive bids, imprudent expansion resulting in a loss, insider trading, unwarranted dividend payment, salaries or compensation, misleading statements filed with the stock exchange, and misrepresentation in acquisition agreement for the purchase of another company. These are just a few of the possible examples of liability risk facing corporate officers and directors.

Various management liability insurance products have been made available to corporations and individuals to address such risks. These products generally provide liability coverage for legal expenses and liability to shareholders, bondholders, creditors or others due to actions or omissions by a director or officer of a corporation or nonprofit organization. That is, they are intended to provide financial protection for the directors and officers of an organization in the event they are sued in conjunction with the performance of their duties as they relate to the company. One type of insurance product offering provides coverage for management errors and omissions. Other types provide coverage relating to losses resulting from employee dishonesty. These products may cover money, securities and property other than money and securities.

While such products meet the insured clients' needs, such insurance policies are difficult to price and manage by companies that issue them because many different factors affect officers' and directors' liability. Accordingly, there is a need for a system and method to consider various factors that affect director and officer liability, and utilize and those considerations to support the determination of an appropriate insurance rate for these types of policies.

### SUMMARY

The present disclosure provides a method and system for determining a rate of insurance for executives of organizations and for determining whether such individuals fall within certain defined risk parameters. The method first determines a base premium. Next, a limit/retention factor and other rating considerations are determined. Such rating factors vary as a function of, among other things, whether the company is structured as a private, public, or not-for-profit organization. Also, the rating factors vary among different industries and groups within the classes of companies. The limit/retention factor and rating considerations are applied to the base premium to ascertain a resultant premium. In this way, the disclosure provides a rate plan framework that includes various factors that may be related and interrelated according to applied weightings. These interrelationships are preferably based on current expectations as defined by an insurer or the like. In this way, the disclosure provides a more objective process for determining and documenting the basis for director and officer liability insurance premiums.

Another aspect of the disclosure determines a shared limit credit when insured clients purchase more than one insurance coverage. In addition, implementation aspects of the disclosure include using validations lists and functions within a spreadsheet to provide ease of use to underwriters when determining rates for director and officer liability insurance.

### BRIEF DESCRIPTION OF THE DRAWINGS

FIG. 1 is a general overview of the system architecture in keeping with the disclosed principles;

FIG. 2 is a detailed illustration of the system architecture in keeping with the disclosed principles;

FIG. 3 is a flow diagram that illustrates an exemplary method of creating a rate plan according to an aspect of the disclosure;

FIG. 4 is a flow diagram that illustrates an exemplary method of determining a rate in accordance to an aspect of the disclosure.

FIG. 5 is another flow diagram that illustrates an exemplary method of calculating a shared limit credit of an aspect of the disclosure in accordance to Example 1;

FIGS. 6A-6C are exemplary spreadsheet implementations of a rating module aspect of the disclosure;

FIG. 7 is an exemplary spreadsheet implementation of a shared limit credit calculation aspect of the disclosure;

FIGS. 8A-D are another exemplary spreadsheet implementations of a shared limit credit calculation aspect of the disclosure;

FIG. 9 is an exemplary Start sheet of a rater spreadsheet application;

FIG. 10 is an exemplary Policy History sheet of a rater spreadsheet application;

FIG. 11 is an exemplary Claims History sheet of a rater spreadsheet application;

FIGS. 12A-B are exemplary Financials sheets of a rater spreadsheet application;

FIG. 13 is an exemplary Work Up sheet of a rater spreadsheet application;

FIG. 14 is an exemplary Rating sheet of a rater spreadsheet application; and

FIG. 15 is an exemplary Options sheet of a rater spreadsheet application.

### DETAILED DESCRIPTION OF THE DISCLOSURE

This disclosure relates to a method for determining an insurance premium for a policy covering executives of organizations and for determining whether and where such individuals fall within certain risk parameters. An embodiment of the disclosure may be used to provide support for the insurance premium charged for liability insurance covering directors and officers of organizations. In addition, the disclosure may be to determine liability coverage for management of limited liability corporations or other legal entities. The method determines premiums for officers and directors of public companies, private companies, and not-for-profit companies or other organizations. The method determines a base premium, a limit/retention factor and a shared limit credit. The method then applies each rating factor to the base premium to provide a resultant premium. In this way, the method provides for an objective documenting of the appropriateness of a premium for director and officer liability insurance.

In a preferred embodiment, a method according to the disclosure is implemented as a series of instructions executable on a computing system or other appropriate data processing system. As an example, the disclosure is implemented in a Microsoft Office Excel™ spreadsheet or on any other suitable spreadsheet application.

### Overall System Architecture

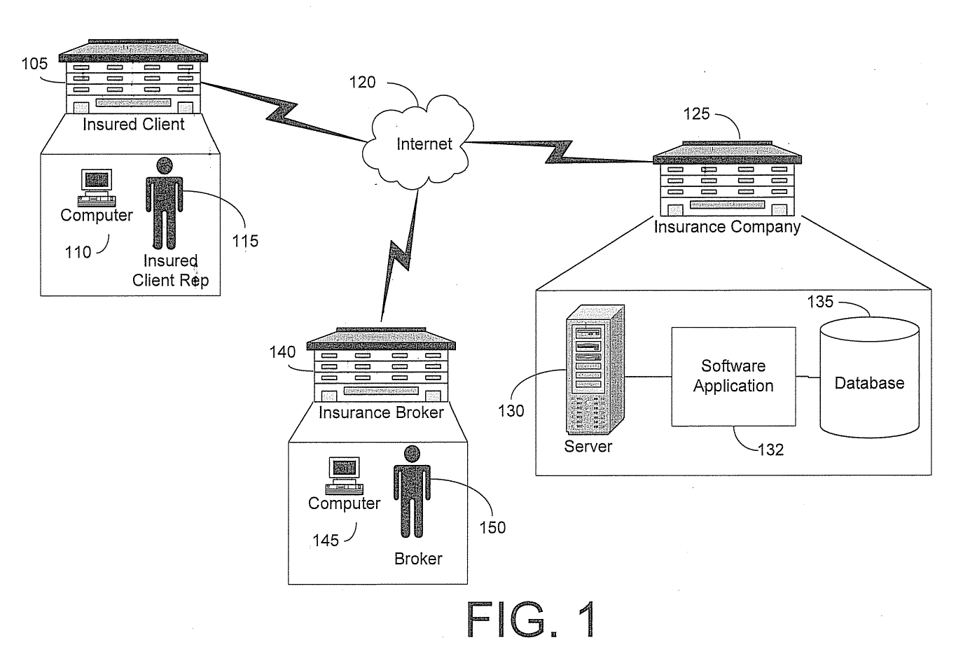

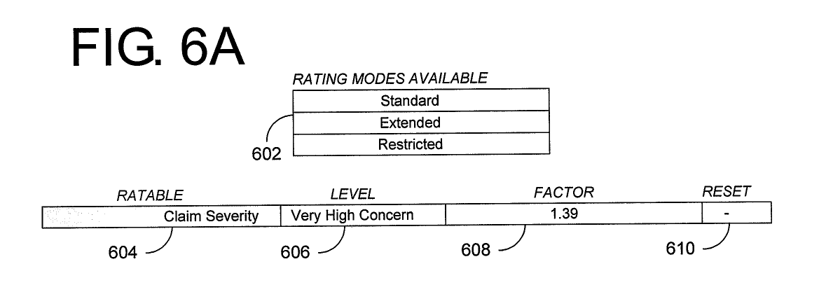

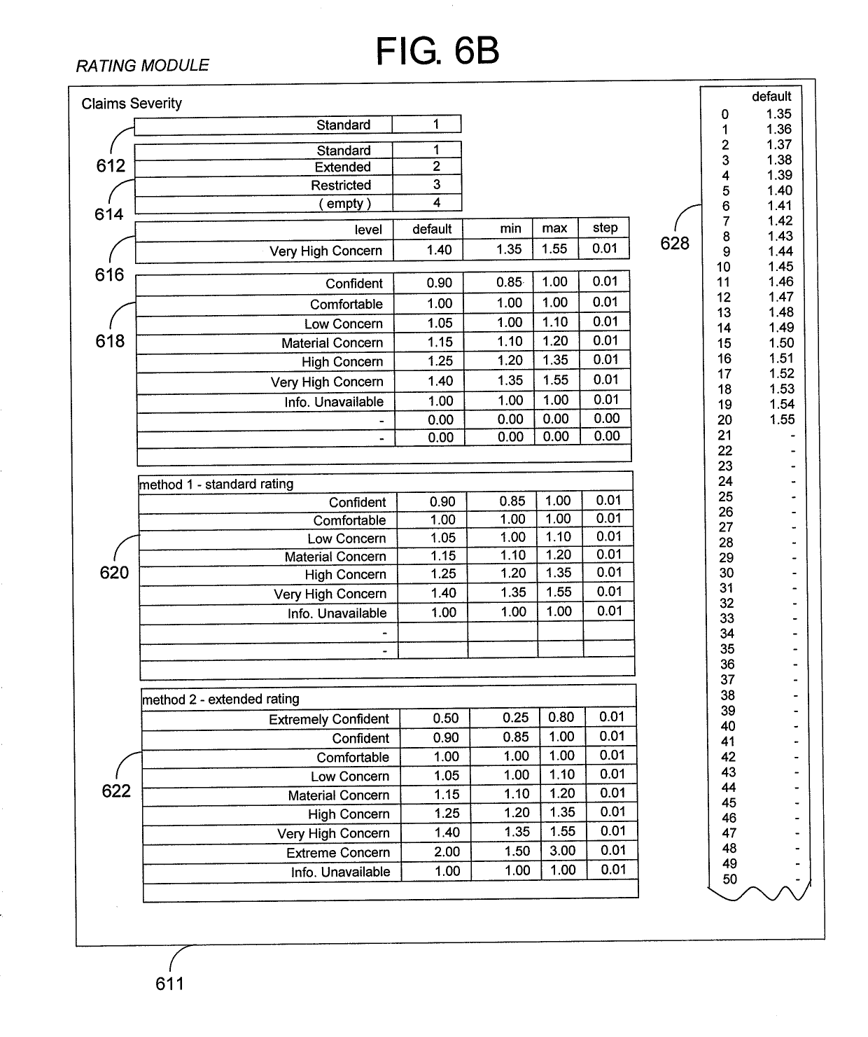

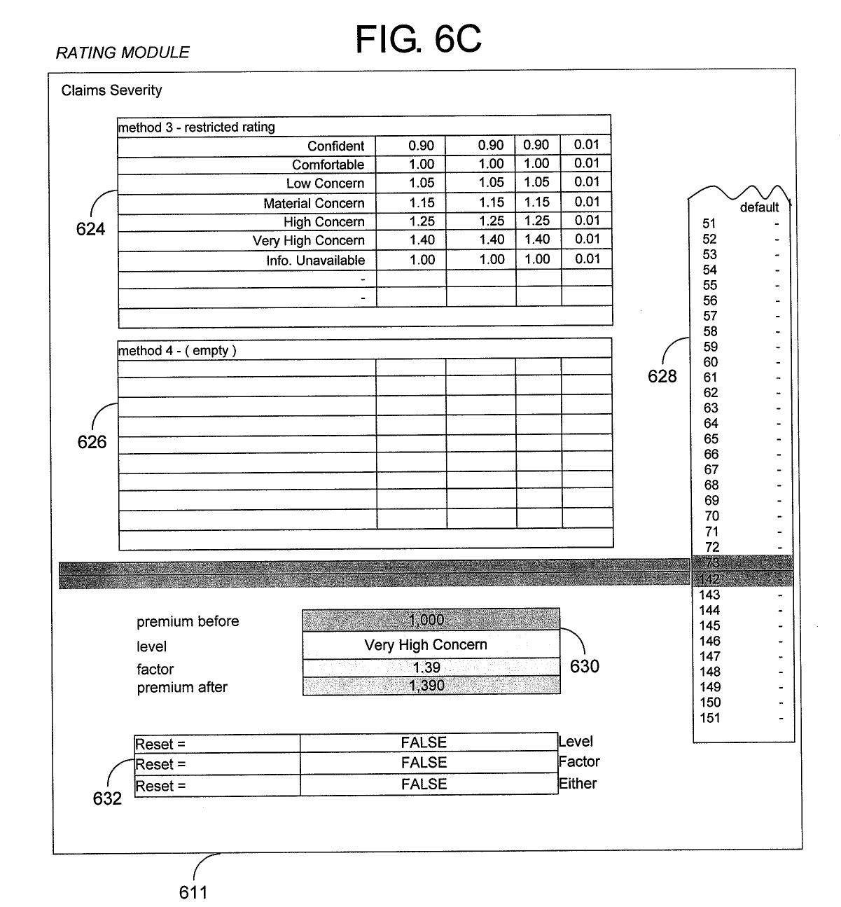

FIG. 1 is a general overview of the system architecture in keeping with the disclosed principles. Embodiments of the disclosure may provide an insured client representative 115 to an insurance broker 150 with insured client data across the Internet 120. The underwriter or other insurance company representative may complete a rater spreadsheet application 132 that then relays that information in a software application designed for documenting insurance rates, issuing policies, and managing the underwriting process using software created for that purpose 132 (online implementation). Alternatively, the method may be implemented in a stand alone spreadsheet application, separate from the insurers other systems, and the information collected and resultant premium analyzed and, where and when appropriate transferred to the underwriting management system. (offline implementation). The online implementation may be part of a computer network system (130-135) within an insurance company 125. The online and offline implementation of the aspects of the disclosure will be further discussed later in the disclosure. The networked computer system may include one or more servers 130, one or more software applications 132, and one or more databases 135. A rater spreadsheet application uses the entered insured client data and the insurance package information to choose a set of appropriate factors such that an underwriter 150 may determine the rate of insurance. Exemplary embodiments of the rater spreadsheet application will be discussed when describing FIGS. 6-15. Further, details of the factors will be discussed later in this disclosure.

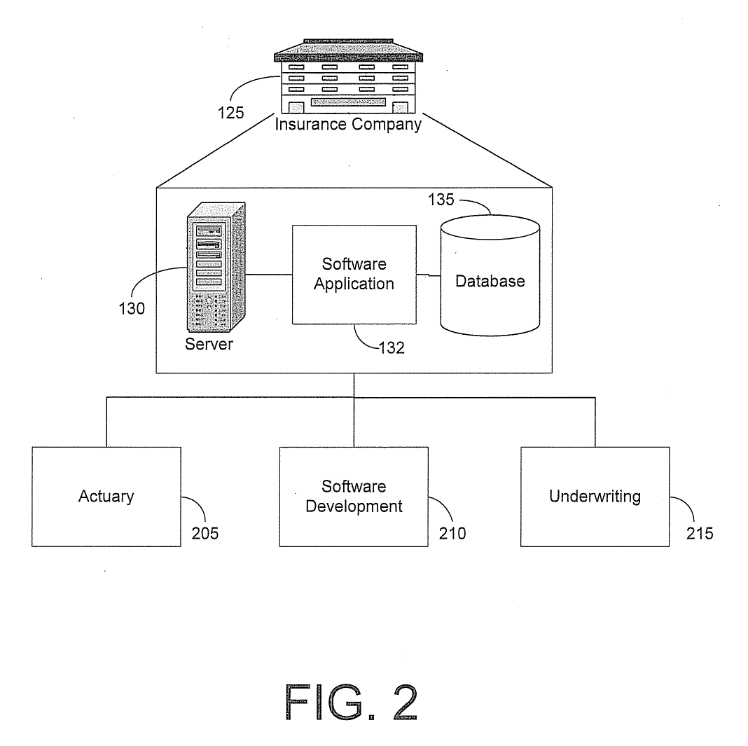

FIG. 2 is a detailed illustration of the system architecture in keeping with the disclosed principles. FIG. 2 shows that at least three functional groups within an insurance company 125 that may implement aspects of the disclosure. An actuary group 205 uses actuarial science techniques familiar to those persons with ordinary skill in the art to construct the base premiums, marginal rates, limit/retention factor and shared limit credits discussed in the following description and illustrated in the following tables. The actuary group 205, underwriting group 215, and compliance group (not shown) work together to determine an appropriate group of risk factors such as those discussed below and illustrated in the following exemplary Tables 6-29. The tables may be stored in one or more databases 130. Further, a software development group 210 within an insurance company 125 may develop one or more software applications 132 to implement the disclosure as part of the computer networked system within the insurance company 125. This includes the rater spreadsheet application that may access the values in the following tables that are stored in a plurality of spreadsheet applications and a plurality of databases 130. An underwriting group 215 uses a rater spreadsheet software application 132 to enter data regarding an insured client and to determine an appropriate rate of insurance for insurance coverage and properly document such determination.

The following description discusses the details of the base premiums, marginal rates, limit/retention factors, shared limit credits, and other risk factors that are constructed using actuarial science and other risk analysis techniques. They are discussed according to a comprehensive rating plan for a publicly traded company. However, embodiments may determine D&O rates of insurance and comprehensive rating plans for other types of companies such as, but not limited to, private companies and not-for-profit organizations. In addition, embodiments may determine rates of insurance for all company types under a basic rating plan appropriate for smaller insured clients.

### Comprehensive Rating Plan for a Public Company

In one aspect, the disclosure provides a comprehensive public company rating model that is geared for supporting the pricing of coverage for large to very large public companies facing numerous and very complex director and officer liability exposure. For deriving various rating factor values, significant underwriting analysis of the public company's financials, claims histories, stock activity, litigation activity, merger and acquisition history, management experience/expertise, as well as other public company risk characteristics, is undertaken.

Examples of underwriting criteria and parameters that are applicable for all types and classes of companies include a base premium, a limit/retention factor, a claims history factor, a financial condition factor, an industry factor, a years in operation factor, a mergers and acquisitions factor, a management experience and qualifications factor, a litigation factor, an entity or non-entity coverage factor and a revenue and asset factor. The aforementioned criteria and parameters applicable for all types of companies are discussed in turn below as they apply to one of the possible types of companies. Additional parameters may be considered for each type and class of company and summarized in additional factors or modifiers. In one embodiment, these additional parameters may determine a public company modifier for public companies, a private company modifier for private companies and a non-profit organization modifier for non-profit organizations.

In a preferred embodiment, base premiums are viewed as a baseline premium for any given director and officer liability insurance policy. The base premium is adjusted based on the above-mentioned underwriting criteria and parameters to derive a resultant premium. For example, the resultant premium may be the same as the base premium in situations where all underwriting criteria and parameters are neutral, thereby having a factor of one. It should be appreciated that for certain risk factors, a neutral level may allow a range of values and not always correspond to a factor value of one.

In an embodiment, a method for determining a base premium for directors and officers liability insurance for public company directors and officers includes providing a database having tables of base premiums stored therein. The database provides a range of base premiums according to the asset size of the public company and whether the public company is a financial institution. The following is an exemplary table of base premiums for public companies.

TABLE 1

| | INITIAL | MARGINAL | INITIAL | MARGINAL |
|---|---|---|---|---|
| | PREMIUM | RATE | PREMIUM | RATE |
| | ALL Public except | | Public Financial | |
| ASSET SIZE | Financial Institutions | | Institutions ONLY | |
| THE FIRST $2.5M OR ANY PART THEREOF | $21,120 | | $12,600 | |
| EACH ADDITIONAL $100K UP TO A TOTAL OF $5M | | $101 | | $85 |
| THE FIRST $5M | $23,645 | | $14,725 | |
| EACH ADDITIONAL $1M UP TO A TOTAL OF 10M | | $564 | | $496 |
| THE FIRST $10M | $26,465 | | $17,205 | |
| EACH ADDITIONAL $1M UP TO A TOTAL OF $15M | | $361 | | $328 |
| THE FIRST $15M | $28,270 | | $18,845 | |
| EACH ADDITIONAL $1M UP TO A TOTAL OF $20M | | $271 | | $251 |
| THE FIRST $20M | $29,625 | | $20,100 | |
| EACH ADDITIONAL $1M UP TO A TOTAL OF $25M | | $219 | | $206 |
| THE FIRST $25M | $30,720 | | $21,130 | |
| EACH ADDITIONAL $5M UP TO A TOTAL OF $50M | | $733 | | $711 |
| THE FIRST $50M | $34,385 | | $24,685 | |
| EACH ADDITIONAL $5M UP TO A TOTAL OF $75M | | $469 | | $470 |
| THE FIRST $75M | $36,730 | | $27,035 | |
| EACH ADDITIONAL $5M UP TO A TOTAL OF $100M | | $352 | | $361 |
| THE FIRST $100M | $38,490 | | $28,840 | |
| EACH ADDITIONAL $10M UP TO A TOTAL OF $250M | | $412 | | $439 |
| THE FIRST $250M | $44,670 | | $35,425 | |
| EACH ADDITIONAL $10M UP TO A TOTAL OF $500M | | $213 | | $238 |
| THE FIRST $500M | $49,995 | | $41,375 | |
| EACH ADDITIONAL $10M UP TO A TOTAL OF $1 B | | $119 | | $139 |
| THE FIRST $1 B | $55,945 | | $48,325 | |
| EACH ADDITIONAL $100M UP TO A TOTAL OF $5 B | | $419 | | $526 |
| THE FIRST $5 B | $72,705 | | $69,365 | |
| EACH ADDITIONAL $100M UP TO A TOTAL OF $10 B | | $174 | | $233 |
| THE FIRST $10 B | $81,405 | | $81,015 | |
| EACH ADDITIONAL $100M UP TO A TOTAL OF $25 B | | $87 | | $123 |
| THE FIRST $25 B | $94,455 | | $99,465 | |
| EACH ADDITIONAL $1 B UP TO A TOTAL OF $50 B | | $451 | | $670 |
| THE FIRST $50 B | $105,730 | | $116,215 | |
| EACH ADDITIONAL $1 B UP TO A TOTAL OF $100 B | | $252 | | $391 |
| THE FIRST $100 B | $118,330 | | $135,765 | |
| EACH ADDITIONAL $1 B UP TO A TOTAL OF $500 B | | $89 | | $148 |
| THE FIRST $500 B | $153,930 | | $194,965 | |
| EACH ADDITIONAL $10 B | | $367 | | $656 |

Other embodiments include base premium tables and a method for determining base premiums for directors and officers liability insurance for private companies and not-for-profit organizations, similar to Table 1. Each base premium table within a database varies the base premium value according to the asset size of the public, private or not-for profit organization. The base premium tables for not-for-profit organization may also distinguish between different classes of organizations. For example, one embodiment may provide one set of base premiums for hospitals, educational, child care organizations and other organizations determined to have an elevated risk of liability, and a second set of base premiums for other not-for-profit organizations, such as arts-related organizations, foundations and social clubs.

Note that certain base premium tables for certain class of companies may be organized differently. For example, in Table 1, the base premium is based primarily on asset size in terms of dollars. However, for example, for a condominium not-for-profit entity, a base premium table may be organized primarily in terms of the number of condominium units.

The tables providing base premiums and marginal rates for different types and classes of companies are constructed using actuarial science techniques familiar to those persons with ordinary skill in the art.

A limit/retention factor is accounted for when calculating a comprehensive premium for all classes of companies. The limit of liability (or limit) is the maximum amount of money the insurer will pay under the policy. The retention, or self-insured retention (SIR), is the amount the insured must pay toward a claim before the insurer will pay.

A method for determining a limit/retention factor for directors and officers liability insurance for public company directors and officers includes providing a database table having limit/retention factors stored therein. For example, smaller limit/retention factors are associated with lower limits of liability and larger retentions while larger limit/retention factors are associated with larger limits of liability and smaller retentions. The following exemplary table provides limit/retention factor values for public companies. Linear interpolation may be performed for limit/retention options not found in the table.

TABLE 2

| Limit | SIR (000) | | | | | | | | | |
|---|---|---|---|---|---|---|---|---|---|---|
| (000) | 10 | 25 | 50 | 75 | 100 | 150 | 200 | 250 | 500 | 750 |
| 500 | 0.6530 | 0.6339 | 0.6133 | 0.6006 | 0.5913 | 0.5738 | 0.5564 | 0.5389 | 0.4391 | 0.3630 |
| 750 | 0.8961 | 0.8740 | 0.8483 | 0.8304 | 0.8160 | 0.7883 | 0.7605 | 0.7328 | 0.6082 | 0.5321 |
| 1,000 | 1.0891 | 1.0654 | 1.0372 | 1.0169 | 1.0000 | 0.9673 | 0.9346 | 0.9019 | 0.7773 | 0.7012 |
| 2,000 | 1.7641 | 1.7384 | 1.7069 | 1.6832 | 1.6629 | 1.6234 | 1.5839 | 1.5445 | 1.3861 | 1.2762 |
| 3,000 | 2.3043 | 2.2772 | 2.2432 | 2.2172 | 2.1945 | 2.1502 | 2.1060 | 2.0617 | 1.8794 | 1.7455 |
| 4,000 | 2.7494 | 2.7220 | 2.6874 | 2.6608 | 2.6375 | 2.5921 | 2.5478 | 2.5014 | 2.3134 | 2.1739 |
| 5,000 | 3.1720 | 3.1441 | 3.1089 | 3.0816 | 3.0577 | 3.0110 | 2.9644 | 2.9177 | 2.7232 | 2.5772 |
| 6,000 | 3.5687 | 3.5406 | 3.5051 | 3.4775 | 3.4532 | 3.4059 | 3.3585 | 3.3112 | 3.1133 | 2.9639 |
| 7,000 | 3.9519 | 3.9236 | 3.8878 | 3.8600 | 3.8354 | 3.7875 | 3.7397 | 3.6918 | 3.4912 | 3.3391 |
| 8,000 | 4.3243 | 4.2960 | 4.2601 | 4.2321 | 4.2075 | 4.1594 | 4.1113 | 4.0632 | 3.8615 | 3.7083 |
| 9,000 | 4.6924 | 4.6640 | 4.6280 | 4.5999 | 4.5752 | 4.5269 | 4.4786 | 4.4303 | 4.2277 | 4.0735 |
| 10,000 | 5.0565 | 5.0280 | 4.9918 | 4.9635 | 4.9385 | 4.8897 | 4.8410 | 4.7922 | 4.5871 | 4.4306 |
| 15,000 | 6.8297 | 6.8009 | 6.7642 | 6.7354 | 6.7099 | 6.6601 | 6.6104 | 6.5606 | 6.3506 | 6.1891 |
| 20,000 | 8.5037 | 8.4746 | 8.4374 | 8.4081 | 8.3822 | 8.3315 | 8.2807 | 8.2300 | 8.0152 | 7.8489 |
| 25,000 | 10.0818 | 10.0524 | 10.0147 | 9.9848 | 9.9583 | 9.9064 | 9.8546 | 9.8027 | 9.5823 | 9.4104 |
| 30,000 | 11.5471 | 11.5171 | 11.4784 | 11.4476 | 11.4202 | 11.3665 | 11.3127 | 11.2590 | 11.0293 | 10.8481 |
| 35,000 | 12.8262 | 12.7956 | 12.7557 | 12.7238 | 12.6953 | 12.6393 | 12.5833 | 12.5273 | 12.2864 | 12.0939 |
| 40,000 | 13.8801 | 13.8490 | 13.8085 | 13.7758 | 13.7466 | 13.6892 | 13.6318 | 13.5744 | 13.3264 | 13.1268 |
| 45,000 | 14.7929 | 14.7613 | 14.7198 | 14.6863 | 14.6561 | 14.5969 | 14.5378 | 14.4786 | 14.2215 | 14.0130 |
| 50,000 | 15.5249 | 15.4920 | 15.4486 | 15.4130 | 15.3808 | 15.3175 | 15.2542 | 15.1909 | 14.9134 | 14.6844 |
| 100,000 | 18.7602 | 18.7268 | 18.6825 | 18.6461 | 18.6130 | 18.5480 | 18.4831 | 18.4181 | 18.1322 | 17.8947 |
| Limit | SIR (000) | | | | | | | | | |
| (000) | 1,000 | 2,000 | 3,000 | 4,000 | 5,000 | 6,000 | 7,000 | 8,000 | 9,000 | 10,000 |
| 500 | 0.3382 | 0.2706 | 0.2227 | 0.2114 | 0.1984 | 0.1917 | 0.1862 | 0.1840 | 0.1821 | 0.1773 |
| 750 | 0.5073 | 0.4059 | 0.3340 | 0.3171 | 0.2976 | 0.2875 | 0.2794 | 0.2761 | 0.2732 | 0.2660 |
| 1,000 | 0.6764 | 0.5411 | 0.4453 | 0.4228 | 0.3968 | 0.3833 | 0.3725 | 0.3681 | 0.3643 | 0.3547 |
| 2,000 | 1.2176 | 0.9865 | 0.8681 | 0.8196 | 0.7802 | 0.7558 | 0.7406 | 0.7324 | 0.7189 | 0.7094 |
| 3,000 | 1.6629 | 1.4092 | 1.2649 | 1.2029 | 1.1526 | 1.1239 | 1.1048 | 1.0870 | 1.0736 | 1.0640 |
| 4,000 | 2.0857 | 1.8061 | 1.6483 | 1.5754 | 1.5207 | 1.4882 | 1.4595 | 1.4417 | 1.4283 | 1.4187 |
| 5,000 | 2.4825 | 2.1894 | 2.0207 | 1.9435 | 1.8850 | 1.8428 | 1.8142 | 1.7964 | 1.7830 | 1.7734 |
| 6,000 | 2.8658 | 2.5619 | 2.3888 | 2.3078 | 2.2397 | 2.1975 | 2.1689 | 2.1511 | 2.1377 | 2.1082 |
| 7,000 | 3.2383 | 2.9300 | 2.7531 | 2.6625 | 2.5944 | 2.5522 | 2.5236 | 2.5057 | 2.4725 | 2.4431 |
| 8,000 | 3.6064 | 3.2943 | 3.1078 | 3.0171 | 2.9490 | 2.9069 | 2.8782 | 2.8406 | 2.8073 | 2.7779 |
| 9,000 | 3.9707 | 3.6489 | 3.4625 | 3.3718 | 3.3037 | 3.2616 | 3.2131 | 3.1754 | 3.1422 | 3.1127 |
| 10,000 | 4.3254 | 4.0036 | 3.8171 | 3.7265 | 3.6584 | 3.5964 | 3.5479 | 3.5103 | 3.4770 | 3.4476 |
| 15,000 | 6.0789 | 5.7373 | 5.5310 | 5.4205 | 5.3326 | 5.2514 | 5.1838 | 5.1269 | 5.0745 | 5.0259 |
| 20,000 | 7.7339 | 7.3732 | 7.1477 | 7.0180 | 6.9109 | 6.8072 | 6.7170 | 6.6377 | 6.5627 | 6.4915 |
| 25,000 | 9.2897 | 8.9064 | 8.6584 | 8.5062 | 8.3766 | 8.2356 | 8.1082 | 7.9917 | 7.8795 | 7.7711 |
| 30,000 | 10.7182 | 10.2976 | 10.0124 | 9.8230 | 9.6561 | 9.4701 | 9.2976 | 9.1360 | 8.9787 | 8.8253 |
| 35,000 | 11.9526 | 11.4870 | 11.1567 | 10.9222 | 10.7103 | 10.4961 | 10.2954 | 10.1055 | 9.9201 | 9.7384 |
| 40,000 | 12.9786 | 12.4848 | 12.1263 | 11.8636 | 11.6234 | 11.3732 | 11.1364 | 10.9105 | 10.6890 | 10.4713 |
| 45,000 | 13.8557 | 13.3258 | 12.9312 | 12.6325 | 12.3563 | 12.0241 | 11.7055 | 11.3977 | 11.0944 | 10.7948 |
| 50,000 | 14.5067 | 13.8949 | 13.4185 | 13.0379 | 12.6798 | 12.3477 | 12.0291 | 11.7213 | 11.4179 | 11.1184 |
| 100,000 | 17.7086 | 17.0631 | 16.5530 | 16.1387 | 15.7469 | 15.3811 | 15.0287 | 14.6873 | 14.3502 | 14.0169 |

| Limit | SIR (000) | | | | | | | | |
|---|---|---|---|---|---|---|---|---|---|
| (000) | 15,000 | 20,000 | 25,000 | 30,000 | 35,000 | 40,000 | 45,000 | 50,000 | 100,000 |
| 500 | 0.1674 | 0.1578 | 0.1466 | 0.1280 | 0.1054 | 0.0913 | 0.0733 | 0.0324 | 0.0155 |
| 750 | 0.2511 | 0.2368 | 0.2198 | 0.1919 | 0.1581 | 0.1370 | 0.1099 | 0.0485 | 0.0233 |
| 1,000 | 0.3348 | 0.3157 | 0.2931 | 0.2559 | 0.2108 | 0.1826 | 0.1466 | 0.0647 | 0.0310 |
| 2,000 | 0.6697 | 0.6313 | 0.5862 | 0.5118 | 0.4216 | 0.3653 | 0.2931 | 0.1294 | 0.0620 |
| 3,000 | 1.0045 | 0.9470 | 0.8794 | 0.7678 | 0.6325 | 0.5479 | 0.4397 | 0.1941 | 0.0930 |
| 4,000 | 1.3393 | 1.2627 | 1.1725 | 1.0237 | 0.8433 | 0.7306 | 0.5862 | 0.2589 | 0.1240 |
| 5,000 | 1.6742 | 1.5784 | 1.4656 | 1.2796 | 1.0541 | 0.9132 | 0.7328 | 0.3236 | 0.1550 |
| 6,000 | 1.9899 | 1.8715 | 1.7215 | 1.4904 | 1.2368 | 1.0598 | 0.7975 | 0.3883 | 0.1860 |
| 7,000 | 2.3055 | 2.1646 | 1.9775 | 1.7012 | 1.4194 | 1.2063 | 0.8622 | 0.4530 | 0.2170 |
| 8,000 | 2.6212 | 2.4577 | 2.2334 | 1.9121 | 1.6020 | 1.3529 | 0.9269 | 0.5177 | 0.2480 |
| 9,000 | 2.9369 | 2.7508 | 2.4893 | 2.1229 | 1.7847 | 1.4994 | 0.9917 | 0.5824 | 0.2790 |
| 10,000 | 3.2525 | 3.0440 | 2.7452 | 2.3337 | 1.9673 | 1.6460 | 1.0564 | 0.6471 | 0.3100 |
| 15,000 | 4.7182 | 4.3236 | 3.7993 | 3.2469 | 2.7001 | 1.9696 | 1.3799 | 0.9707 | 0.4651 |
| 20,000 | 5.9977 | 5.3777 | 4.7125 | 3.9797 | 3.0237 | 2.2931 | 1.7035 | 1.2943 | 0.6201 |
| 25,000 | 7.0519 | 6.2909 | 5.4453 | 4.3033 | 3.3472 | 2.6167 | 2.0271 | 1.6178 | 0.7751 |
| 30,000 | 7.9651 | 7.0237 | 5.7689 | 4.6268 | 3.6708 | 2.9402 | 2.3506 | 1.9414 | 0.9301 |
| 35,000 | 8.6979 | 7.3472 | 6.0924 | 4.9504 | 3.9944 | 3.2638 | 2.6742 | 2.2649 | 1.0851 |
| 40,000 | 9.0214 | 7.6708 | 6.4160 | 5.2740 | 4.3179 | 3.5874 | 2.9977 | 2.5885 | 1.2401 |
| 45,000 | 9.3450 | 7.9944 | 6.7396 | 5.5975 | 4.6415 | 3.9109 | 3.3213 | 2.9121 | 1.3952 |
| 50,000 | 9.6685 | 8.3179 | 7.0631 | 5.9211 | 4.9651 | 4.2345 | 3.6449 | 3.2356 | 1.5502 |
| 100,000 | 12.3985 | 10.8794 | 9.4560 | 8.1454 | 7.0209 | 6.1218 | 5.3636 | 4.7858 | 3.1003 |

Similar limit/retention tables may be constructed for private companies and not-for-profit organizations. The tables illustrating limit/retention factors for different types of companies are constructed using actuarial science techniques familiar to those persons with ordinary skill in the art.

A shared limit credit is determined if one limit of liability is applicable to the director and officer liability insurance coverage in addition to one or more other types of insurance coverages provided by the policy. For example, the shared limit credit may apply when the director and officer policy is part of a management liability package policy, which also includes employment practices liability and/or fiduciary liability coverage and all coverages fall within a single limit.

In a preferred embodiment, the shared limit credit is applied to the premium of each coverage in the package policy that is sharing the limit. For example, a policy may contain coverage for director and officer liability, employment practices liability, and fiduciary liability sharing a common $5 million limit. In an embodiment, a method for determining the shared limit credit for directors and officers liability insurance when each coverage in the package policy is sharing the same limit is to provide database tables having shared limit credit values stored therein. A novel aspect of the disclosure includes a method of determining a shared limit credit where there are more than two coverages in a policy or insurance package. The following exemplary table provides shared limit credit values for situations wherein each coverage in the package policy is sharing the same limit. The exemplary table shows shared limit credit values applicable for two and more than two coverages.

TABLE 3

| Shared | Two | More Than Two |
|---|---|---|
| Limit | Coverages | Coverages |
| $100K | 0.850 | 0.8032 |
| $250K | 0.875 | 0.835 |
| $500K | 0.900 | 0.867 |
| $1M | 0.920 | 0.893 |
| $2M | 0.940 | 0.920 |
| $3M | 0.955 | 0.940 |
| $4M | 0.964 | 0.952 |
| $5M | 0.9725 | 0.9630 |
| $6M | 0.9833 | 0.9779 |
| $7M | 0.9904 | 0.9876 |
| $8M | 0.9946 | 0.9932 |
| $9M | 0.9976 | 0.9970 |
| $10M and above | 1.00 | 1.00 |

Other shared limit situations include varying sub-limits which vary among coverages. For example, when each of the director and officer liability, the employment practices liability, and the fiduciary liability share an aggregate $5M limit of liability, but employment practices liability has a $4M sub-limit, and fiduciary liability has a $2M sub-limit (and thus neither of the sub-limited coverages can exhaust the $5M aggregate limit). A novel aspect of the disclosure includes a method of determining a shared limit credit across multiple coverages with varying sub-limits. An embodiment of the disclosure provides a method for determining the shared limit credit for directors and officers liability insurance when each coverage in the package policy is sharing the same aggregate limit, but one or more coverages are subject to a lesser sub-limit. The method uses database tables with shared limit credit component values stored therein. For example, the database may include values for a primary shared limit credit and values for determining additional shared limit credits. Each of these shared limit credits is determined by considering a “target limit”, which is the limit of the coverage receiving the credit, and a “max limit”, which is the limit of the coverages that are being shared.

The following exemplary data tables illustrate primary shared limit credit and additional shared limit credit values. If more than two coverages are sharing the same aggregate limit, the primary shared limit table is first used to determine a credit with respect to the coverage with the highest sub-limit (other than the coverage to which the credit will be applied) and the additional shared limit table is used for each additional coverage. The shared limit credit to be used in determining a resultant premium is equal to the primary shared limit multiplied by each of the additional shared limit credits. A shared limit credit may be applied to the premium for each type of coverage in the policy that shares a common limit.

TABLE 4
Primary Shared Limit Table

| Target | Max Limit | | | | | | | | | | | | |
|---|---|---|---|---|---|---|---|---|---|---|---|---|---|
| Limit | 100K | 250K | 500K | 1M | 2M | 3M | 4M | 5M | 6M | 7M | 8M | 9M | 10M |
| 100K | 0.8500 | 0.9500 | 0.9800 | 0.9920 | 0.9970 | 0.9985 | 0.9991 | 0.9995 | 0.9996 | 0.9997 | 0.9998 | 0.9999 | 1.0000 |
| 250K | 0.9500 | 0.8750 | 0.9500 | 0.9800 | 0.9925 | 0.9963 | 0.9978 | 0.9986 | 0.9989 | 0.9992 | 0.9994 | 0.9997 | 1.0000 |
| 500K | 0.9800 | 0.9500 | 0.9000 | 0.9600 | 0.9850 | 0.9925 | 0.9955 | 0.9973 | 0.9978 | 0.9984 | 0.9989 | 0.9995 | 1.0000 |
| 1M | 0.9920 | 0.9800 | 0.9600 | 0.9200 | 0.9700 | 0.9850 | 0.9910 | 0.9945 | 0.9956 | 0.9967 | 0.9978 | 0.9989 | 1.0000 |
| 2M | 0.9970 | 0.9925 | 0.9850 | 0.9700 | 0.9400 | 0.9700 | 0.9820 | 0.9890 | 0.9912 | 0.9934 | 0.9956 | 0.9978 | 1.0000 |
| 3M | 0.9985 | 0.9963 | 0.9925 | 0.9850 | 0.9700 | 0.9550 | 0.9730 | 0.9835 | 0.9868 | 0.9901 | 0.9934 | 0.9967 | 1.0000 |
| 4M | 0.9991 | 0.9978 | 0.9955 | 0.9910 | 0.9820 | 0.9730 | 0.9640 | 0.9780 | 0.9824 | 0.9868 | 0.9912 | 0.9956 | 1.0000 |
| 5M | 0.9995 | 0.9986 | 0.9973 | 0.9945 | 0.9890 | 0.9835 | 0.9780 | 0.9725 | 0.9780 | 0.9835 | 0.9890 | 0.9945 | 1.0000 |
| 6M | 0.9997 | 0.9992 | 0.9984 | 0.9967 | 0.9914 | 0.9861 | 0.9828 | 0.9791 | 0.9833 | 0.9875 | 0.9916 | 0.9958 | 1.0000 |
| 7M | 0.9999 | 0.9996 | 0.9992 | 0.9984 | 0.9932 | 0.9881 | 0.9864 | 0.9841 | 0.9872 | 0.9904 | 0.9936 | 0.9968 | 1.0000 |
| 8M | 0.9999 | 0.9998 | 0.9996 | 0.9992 | 0.9941 | 0.9890 | 0.9882 | 0.9865 | 0.9892 | 0.9919 | 0.9946 | 0.9973 | 1.0000 |
| 9M | 1.0000 | 0.9999 | 0.9999 | 0.9997 | 0.9947 | 0.9897 | 0.9894 | 0.9882 | 0.9905 | 0.9929 | 0.9953 | 0.9976 | 1.0000 |
| 10M | 1.0000 | 1.0000 | 1.0000 | 1.0000 | 0.9950 | 0.9900 | 0.9900 | 0.9890 | 0.9912 | 0.9934 | 0.9956 | 0.9978 | 1.0000 |

TABLE 5
Additional Shared Limit Table

| Target | Max Limit | | | | | | | | | | | | |
|---|---|---|---|---|---|---|---|---|---|---|---|---|---|
| Limit | 100K | 250K | 500K | 1M | 2M | 3M | 4M | 5M | 6M | 7M | 8M | 9M | 10M |
| 100K | 0.9450 | 0.9817 | 0.9927 | 0.9971 | 0.9989 | 0.9995 | 0.9997 | 0.9998 | 0.9998 | 0.9999 | 0.9999 | 1.0000 | 1.0000 |
| 250K | 0.9817 | 0.9543 | 0.9817 | 0.9927 | 0.9973 | 0.9987 | 0.9992 | 0.9995 | 0.9996 | 0.9997 | 0.9998 | 0.9999 | 1.0000 |
| 500K | 0.9927 | 0.9817 | 0.9633 | 0.9853 | 0.9947 | 0.9974 | 0.9984 | 0.9990 | 0.9992 | 0.9994 | 0.9996 | 0.9998 | 1.0000 |
| 1M | 0.9971 | 0.9927 | 0.9853 | 0.9707 | 0.9894 | 0.9948 | 0.9969 | 0.9980 | 0.9984 | 0.9988 | 0.9992 | 0.9996 | 1.0000 |
| 2M | 0.9989 | 0.9973 | 0.9947 | 0.9894 | 0.9787 | 0.9895 | 0.9938 | 0.9961 | 0.9969 | 0.9977 | 0.9984 | 0.9992 | 1.0000 |
| 3M | 0.9995 | 0.9987 | 0.9974 | 0.9948 | 0.9895 | 0.9843 | 0.9907 | 0.9941 | 0.9953 | 0.9965 | 0.9976 | 0.9988 | 1.0000 |
| 4M | 0.9997 | 0.9992 | 0.9984 | 0.9969 | 0.9938 | 0.9907 | 0.9876 | 0.9922 | 0.9938 | 0.9953 | 0.9969 | 0.9984 | 1.0000 |
| 5M | 0.9998 | 0.9995 | 0.9990 | 0.9980 | 0.9961 | 0.9941 | 0.9922 | 0.9902 | 0.9922 | 0.9941 | 0.9961 | 0.9980 | 1.0000 |
| 6M | 0.9999 | 0.9997 | 0.9994 | 0.9988 | 0.9973 | 0.9959 | 0.9945 | 0.9931 | 0.9945 | 0.9959 | 0.9972 | 0.9986 | 1.0000 |
| 7M | 0.9999 | 0.9999 | 0.9997 | 0.9994 | 0.9981 | 0.9972 | 0.9963 | 0.9953 | 0.9962 | 0.9972 | 0.9981 | 0.9991 | 1.0000 |
| 8M | 1.0000 | 0.9999 | 0.9999 | 0.9997 | 0.9986 | 0.9978 | 0.9971 | 0.9964 | 0.9971 | 0.9978 | 0.9986 | 0.9993 | 1.0000 |
| 9M | 1.0000 | 1.0000 | 1.0000 | 0.9999 | 0.9989 | 0.9983 | 0.9977 | 0.9971 | 0.9977 | 0.9983 | 0.9989 | 0.9994 | 1.0000 |
| 10M | 1.0000 | 1.0000 | 1.0000 | 1.0000 | 0.9990 | 0.9985 | 0.9980 | 0.9975 | 0.9980 | 0.9985 | 0.9990 | 0.9995 | 1.0000 |

### Example 1

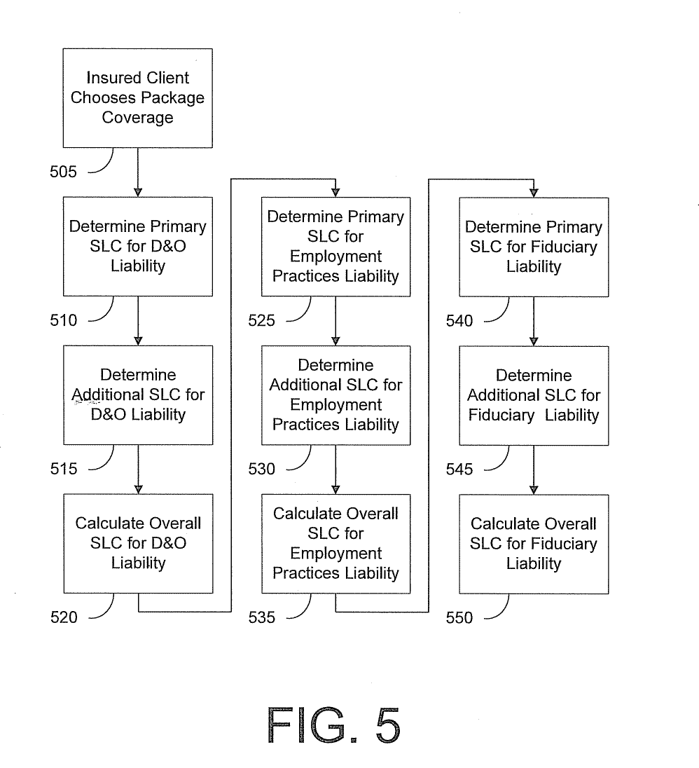

FIG. 5 illustrates an exemplary embodiment illustrating Example 1. This example demonstrates how the shared limits credits are calculated when all coverages in the package policy share the same aggregate limit, but one or more coverages have a sub-limit. In this example, director and officer liability, employment practices liability, and fiduciary liability share a common $5M limit of liability, the full limit applies to directors and officers liability, employment practices liability has a $4M sub-limit, and fiduciary liability has a $2M sub-limit (Step 505 in FIG. 5). Using the above-mentioned tables, the shared limit credit for all three coverages are calculated as follows with indications of the steps from FIG. 5:

Director and Officers Liability:
Primary Shared Limit Credit (to Reflect Director and Officers Liability sharing with employment practices liability) (Step 510 in FIG. 5):
   Target Limit=5M (the Director and Officer Liability Limit)
   Max Limit=4M (the Employment Practices Liability Sublimit)
   Primary Shared Limit Credit=0.9780 (from the Primary Shared Limit Table)
Additional Shared Limit Credits (to reflect Director and Officers Liability sharing with Fiduciary Liability) (Step 515 in FIG. 5):
   Target Limit=5M (the Director and Officer Liability Limit)
   Max Limit=2M (the Fiduciary Liability Sublimit)
   Additional Shared Limit Credit=0.9961 (from the Additional Shared Limit Table)
Shared Limit Credit for Director and Officers Liability=0.9780×0.9961=0.9742 (Step 520 in FIG. 5)

Employment Practices Liability:
Primary Shared Limit Credit (to reflect Employment Practices Liability sharing with Director and Officers Liability) (Step 525 in FIG. 5):
   Target Limit=4M (the Employment Practices Liability Sublimit)
   Max Limit=5M (the Director and Officer Liability)
   Primary Shared Limit Credit=0.9780 (from the Primary Shared Limit Table)
Additional Shared Limit Credits (to reflect Employment Practices Liability sharing with Fiduciary Liability) (Step 530 in FIG. 5):
   Target Limit=4M (the Employment Practices Liability Sublimit)
   Max Limit=2M (the Fiduciary Liability Sublimit)
   Additional Shared Limit Credit=0.9938 (from the Additional Shared Limit Table)
Shared Limit Credit (for Employment Practices Liability)=0.9780×0.9938=0.9719 (Step 535 in FIG. 5)

Fiduciary Liability:
Primary Shared Limit Credit (to reflect Fiduciary Liability sharing with Director and Officer Liability) (Step 540 in FIG. 5):
   Target Limit=2M (the Fiduciary Liability Sublimit)
   Max Limit=5M (the Director and Officer Liability Limit)
   Primary Shared Limit Credit=0.9890 (from the Primary Shared Limit Table)
Additional Shared Limit Credits (to reflect Fiduciary Liability sharing with Employment Practices Liability) (Step 545 in FIG. 5):
   Target Limit=2M (the Fiduciary Liability Sublimit)
   Max Limit=4M (the Employment Practices Liability Sublimit)
   Additional Shared Limit Credit=0.9938 (from the Additional Shared Limit Table)
Shared Limit Credit (for Fiduciary Liability)=0.9890×0.9938=0.9829 (Step 550 in FIG. 5)

The foregoing tables used to determine shared limit credits are constructed using actuarial science techniques familiar to those persons with ordinary skill in the art.

In a preferred embodiment, various rating factors are included in the calculation of a resultant premium. Each rating factor may be determined using objective data relevant to an insured client and/or the level of confidence or concern an underwriter reaches after review a set of considerations relevant to the rating factor. The ratings factors relevant to the determination of a premium for a public company are discussed below.

A claims history factor is included in the resultant premium formula. The claims history factor is based on the considerations below and reflects the degree of underwriting concern or confidence in the likeliness and potential size of future claims based on the account's prior claim history, including the frequency and severity of previous claims. The claims history factor is the product of the claim frequency factor multiplied by the claim severity factor.

Considerations relevant to the determination of the level of confidence or concern with respect to claim frequency include the nature of the claims that have been submitted and encountered, whether any previous claims resulted in insurance payments, whether any previous claims significantly impacted the insured, whether trends exist in the account's claims history, and whether the insured has implemented any corrective measures to improve loss control. Based on these and other considerations, a level of confidence or concern is reached and a rating factor is assigned and included in the formula for determining the claims history factor. The rating factor is selected by the underwriter from the permitted range in a data table such as the following exemplary data table for a claims frequency factor.

TABLE 6

| Degree of Concern/Confidence as regards | |
|---|---|
| Claims Frequency | Rating Factor |
| Confident | 0.85-1.00 |
| Comfortable | 1.00 |
| Low Concern | 1.00-1.10 |
| Material Concern | 1.10-1.20 |
| High Concern | 1.20-1.35 |
| Very High Concern | 1.35-1.55 |

Considerations for determining claim severity include whether there have been any large claim payments experienced by the insured, whether there have been securities claims allegations asserted and, if so, the extent of those allegations, whether punitive damages have ever been awarded as a result of the insured's wrongful acts, whether any class action suits have ever been filed, and whether the insured has implemented any measures to control loss severity. After evaluating these claim severity considerations, a rating factor value is assigned and included in the formula for determining the claims history factor. The following is an exemplary table of claim severity factor values, which can be used by an underwriter to determine the claim severity factor.

TABLE 7

| Degree of Concern/Confidence as regards | |
|---|---|
| Claims Severity | Rating Factor |
| Confident | 0.85-1.00 |
| Comfortable | 1.00 |
| Low Concern | 1.00-1.10 |
| Material Concern | 1.10-1.20 |
| High Concern | 1.20-1.35 |
| Very High Concern | 1.35-1.55 |

Once the claim severity factor value and the claim frequency factor have been determined, the two values are multiplied together to provide a claims history factor. The claims history factor is included in the resultant premium formula.

In a preferred embodiment, a financial condition factor is also included in the resultant premium formula. The financial condition factor reflects the degree of underwriting concern or confidence in the account's financial health. The factor is based on underwriting analysis of the account's financial statements and ratios. The account's key financial statements, such as its balance sheet, income statement, and statement of cash flows, are analyzed and evaluated individually. Other notable financial information may be analyzed for extraordinary conditions and evaluated accordingly.

The following exemplary data tables may be used to assign rating factor values that reflect the underwriter's degree of concern or confidence regarding the balance sheet, income statement, and statement of cash flows, respectively.

TABLE 8

| Degree of Concern/Confidence as regards | |
|---|---|
| Balance Sheet | Rating Factor |
| Very Confident | 0.80-0.90 |
| Confident | 0.90-1.00 |
| Comfortable | 1.00 |
| Low Concern | 1.00-1.10 |
| Material Concern | 1.10-1.25 |
| High Concern | 1.25-1.50 |
| Very High to Severe Concern | 1.50-2.00 |

TABLE 9

| Degree of Concern/Confidence as regards | |
|---|---|
| Income Statement | Rating Factor |
| Very Confident | 0.80-0.90 |
| Confident | 0.90-1.00 |
| Comfortable | 1.00 |
| Low Concern | 1.00-1.10 |
| Material Concern | 1.10-1.25 |
| High Concern | 1.25-1.50 |
| Very High to Severe Concern | 1.50-2.00 |

TABLE 10

| Degree of Concern/Confidence as regards | |
|---|---|
| Statement of Cash Flows | Rating Factor |
| Very Confident | 0.80-0.90 |
| Confident | 0.90-1.00 |
| Comfortable | 1.00 |
| Low Concern | 1.00-1.10 |
| Material Concern | 1.10-1.25 |
| High Concern | 1.25-1.50 |
| Very High to Severe Concern | 1.50-2.00 |

Considerations for each financial statement include whether it shows favorable or unfavorable results and what results it may forecast for the upcoming years. Where appropriate, a ratio analysis may be performed to allow a basis for a meaningful comparison of the account to other companies in the same industry. Depending on the type of account, the following additional information may be considered, analyzed and measured: profitability indicators (such as operating margin, net margin, cash flow, sales, return on equity and return on assets), liquidity indicators (such as current ratio, quick ratio and working capital); solvency and debt utilization indicators, leverage indicators, price-earnings, equity valuation, stock volatility, and bond information.

In addition to the balance sheet factor, the income statement factor, the statement of cash flows factor, other financial items may be considered to determine an all other financials factor that will be applied. Other financial items are evaluated using the aforementioned considerations and analyzed for extraordinary conditions. Based on this evaluation and analysis, an underwriter develops an appropriate level of confidence or concern and a value is assigned to an “all other financials” rating factor.

The following exemplary data table illustrates rating factor values for the degree of concern or confidence regarding such other notable financial items. These are used to determine an “all other financials” rating factor.

TABLE 11

| Degree of Concern/Confidence with regard to | |
|---|---|
| All Other Financials (exclusive of Balance Sheet, Income | |
| Statement and Statement of Cash Flows) | Rating Factor |
| Very Confident | 0.80-0.90 |
| Confident | 0.90-1.00 |
| Comfortable | 1.00 |
| Low Concern | 1.00-1.10 |
| Material Concern | 1.10-1.25 |
| High Concern | 1.25-1.50 |
| Very High to Severe Concern | 1.50-2.00 |

The financial condition factor is calculated as the product of the balance sheet factor, the income statement factor, the statement of cash flows factor, and the “all other financials” factor. Accordingly, once those factors have been determined, the financial condition factor can be calculated for the resultant premium formula.

An industry factor is also included in the resultant premium formula. The industry factor is determined by assigning a rating factor that reflects the degree of underwriting concern or confidence regarding the director and officer loss exposure existing in the account's industry. The following exemplary data table includes rating factor values that reflect the degree of concern or confidence regarding the industry or types of business and is used by an underwriter to determine an industry rating factor.

TABLE 12

| Degree of Concern/Confidence as regards | |
|---|---|
| Industry/Type of Business | Rating Factor |
| Very Confident | 0.70-0.85 |
| Confident | 0.85-1.00 |
| Comfortable | 1.00 |
| Low Concern | 1.00-1.15 |
| Material Concern | 1.15-1.35 |
| High Concern | 1.35-1.75 |
| Very High to Severe Concern | 1.75-2.25 |

A years in operation factor is also included in the resultant premium formula in a preferred embodiment. The years in operation factor is determined by considering the amount of time the insured has been in operation. The relevance of such time in operation may be further assessed according to its bearing on the particular risk being evaluated.

The following is an exemplary data table of rating factor values that corresponds to the number of years in business, which is used to determine the years in operation factor.

TABLE 13

| | Years in Operation |
|---|---|
| Years in Operation | Factor |
| More than 5 Years | 0.85-1.00 |
| At least 3 Years, but not more than 5 Years | 1.00-1.05 |
| Less than 3 Years | 1.05-1.25 |

A mergers and acquisitions factor is also included in the resultant premium formula. The mergers and acquisitions factor is determined based on the degree of underwriting concern or confidence regarding the account's mergers and acquisitions history and the likelihood of future mergers or acquisitions.

Considerations for determining the mergers and acquisitions factor include whether the account has ever acquired or been acquired by another entity and, if so, the amount of time since the acquisition activity. In addition, the extent or degree of the acquisition activity, whether there are set plans for acquisition activity in the near future, and, if not, whether there are any signs that indicate the possibility of acquisition activity in the near future are considered. Consideration is also given to whether the account has ever consolidated itself or been merged with another entity and, if so, the amount of time since the consolidation or merger activity. The extent or degree of the consolidation or merger activity, whether there are set plans for consolidation or merger activity in the near future, and, if not, whether there are any signs that indicate the possibility of consolidation or merger activity in the near future may also be considered. Generally, a significant amount of merger and acquisition activity will garner more concern while the absence of such activity will heighten the level of confidence.

The following exemplary data table provides rating factor values that reflect the degree of concern or confidence in past and future mergers and acquisitions activity, which can be used to determine a mergers and acquisitions rating factor.

TABLE 14

| Degree of Concern/Confidence in | |
|---|---|
| Mergers & Acquisitions History or | |
| Future Mergers & Acquisitions Activity | Rating Factor |
| Very Confident | 0.80-0.90 |
| Confident | 0.90-1.00 |
| Comfortable or Not Applicable | 1.00 |
| Low Concern | 1.00-1.10 |
| Material Concern | 1.10-1.20 |
| High Concern | 1.20-1.30 |
| Very High to Severe Concern | 1.30-1.50 |

A management experience and qualifications factor is also included in the resultant premium formula. The value of this factor reflects the degree of underwriting concern or confidence regarding the account's management and their qualifications.

Considerations for determining the level of confidence or concern in the experience and qualifications of the management include the extent of the current management's experience in the industry, whether the management has a strong business background, whether the board is diverse with representation in different fields of expertise which can contribute to proper governance of the organization, and whether board members have experience on other boards.

The following exemplary data table includes rating factor values that reflect the degree of concern or confidence in management experience and qualifications.

TABLE 15

| Degree of Concern/Confidence in | |
|---|---|
| Management Experience | |
| and Qualifications | Rating Factor |
| Very Confident | 0.80-0.90 |
| Confident | 0.90-1.00 |
| Comfortable or Not Applicable | 1.00 |
| Low Concern | 1.00-1.10 |
| Material Concern | 1.10-1.20 |
| High Concern | 1.20-1.30 |
| Very High to Severe Concern | 1.30-1.50 |

A litigation factor is also included in the resultant premium formula. This factor is determined by assigning a rating factor that reflects the degree of underwriting concern or confidence regarding the account's pending litigation and existing conditions that could potentially lead to future litigation. The litigation factor may be calculated as the product of a director and officer related litigation factor and an other corporate litigation factor.

The following exemplary data tables are used to determine the director and officer related litigation factor and other corporate litigation factors based on the underwriter's degree of concern or confidence.

TABLE 16

| Degree of Concern/Confidence as regards | |
|---|---|
| current D&O Litigation | Rating Factor |
| Very Confident | 0.80-0.90 |
| Confident | 0.90-1.00 |
| Comfortable or Not Applicable | 1.00 |
| Low Concern | 1.00-1.10 |
| Material Concern | 1.10-1.20 |
| High Concern | 1.20-1.30 |

TABLE 17

| Degree of Concern/Confidence as regards | |
|---|---|
| current Corporate Litigation | |
| (other than Director and Officer Litigation) | Rating Factor |
| Very Confident | 0.80-0.90 |
| Confident | 0.90-1.00 |
| Comfortable or Not Applicable | 1.00 |
| Low Concern | 1.00-1.10 |
| Material Concern | 1.10-1.20 |
| High Concern | 1.20-1.30 |

The litigation factor is the product of the director and officer related litigation factor and the other corporate litigation factor. Accordingly, once those factors have been determined, the litigation factor is determined and included in the resultant premium formula.

An entity or non-entity coverage factor is included in the resultant premium formula. The entity or non-entity coverage factor reflects the premium impact of providing coverage on a non-entity basis as opposed to providing full entity coverage. Removal of entity coverage may result in a credit, depending on the resulting increase in underwriting confidence.

The following exemplary data table provides entity or non-entity coverage factor values.

TABLE 18

| Entity Coverage: | Entity/Non-Entity |
|---|---|
| Entity Coverage NOT provided: | Coverage Factor: |
| No Increased Confidence | 1.00 |
| Minimal Reassurance | 0.90-1.00 |
| Nominal Reassurance | 0.85-0.90 |
| Significant Reassurance | 0.80-0.85 |
| Not Applicable | 1.00 |

A revenue and asset irregularities factor is also included in the resultant premium formula for public and private companies. The revenue and asset irregularities factor is applied to account for any significant irregularity between the account's total assets and total revenues. The revenue and asset irregularities factor is determined by assigning a rating factor that reflects the degree of underwriting concern regarding an account where such an irregularity between asset size and revenues exists.

For example, a company that has a very high asset base, but a significantly lower revenue base, may prompt an increased underwriting concern. Such characteristics may indicate that the company carries an unusually high amount of goodwill on the balance sheet. Goodwill or other intangible assets reflect value above the recognized value of the tangible assets of a company. The revenue and asset irregularities factor is used to account for any unusual variances between the ratio of the company's assets and revenues as compared to what is considered a normal ratio for its peer group.

The following is an exemplary data table of rating factor values that reflects the degree of underwriting concern with an irregularity between asset size and revenues. This table is used to determine a revenue and asset irregularities factor.

TABLE 19

| Degree of Concern with regard to Revenue/Asset | |
|---|---|
| Irregularities | Rating Factor |
| No Irregularities/No Concern over Irregularities | 1.00 |
| Low Concern over existing Irregularities | 1.10-1.25 |
| Moderate Concern over existing Irregularities | 1.25-1.40 |
| High Concern over existing Irregularities | 1.40-1.75 |

A specialty coverage factor may be included in the resultant premium formula. The specialty coverage factor accounts for increased risk of providing additional coverages, either selected by the insured or provided as mandatory (as required by certain state laws). The specialty coverage factor is the product of a punitive damages exposure factor and a prior acts coverage factor.

The following exemplary data table determines a punitive damages exposure factor based on the presence or absence of punitive damages coverage and, if such coverage is provided, the underwriter's level of concern.

TABLE 20

| | Punitive Damages |
|---|---|
| | Coverage Factor: |
| Punitive Damages Exposure: | |
| Punitive Damages Coverage NOT SELECTED | 1.00 |
| Punitive Damages Coverage SELECTED but NOT | 1.00-1.15 |
| INSURABLE in Domicile State: | |
| Punitive Damages Coverage SELECTED and | |
| INSURABLE in Domicile State: | |
| Low Concern | 1.10-1.20 |
| Moderate | 1.20-1.30 |
| High Concern | 1.30-1.40 |
| Punitive Damages Coverage MANDATORY | |
| in Domicile State: | |
| Low Concern | 1.10-1.20 |
| Moderate | 1.20-1.30 |
| High Concern | 1.30-1.40 |

The following is an exemplary data table of the prior acts coverage factor based on the number of years of prior act coverage to be provided.

TABLE 21

| | PRIOR ACTS |
|---|---|
| | COVERAGE |
| PRIOR ACTS COVERAGE BEING GRANTED | FACTOR |
| 5 years prior acts/full prior acts | 1.00 |
| 4 years prior acts | 0.90-0.95 |
| 3 years prior acts | 0.85-0.90 |
| 2 years prior acts | 0.80-0.85 |
| 1 year prior acts | 0.75-0.80 |
| no prior acts | 0.70-0.75 |
| no prior acts - Application/other required | 1.00 |
| underwriting information not received | |

In addition to the above-mentioned criteria and parameters considered in the exemplary rating plan for all types and classes of companies, a method according one preferred embodiment includes other criteria and parameters for creating exemplary rating plans for specific types and classes of companies. When determining a resultant premium for a public company, this embodiment first applies the criteria and parameters for all types to determine each of the factors describes above. Accordingly, the method first determines a base premium. Next, the method determines a limit/retention factor, a claims history factor, a financial condition factor, an industry factor, a years in operation factor, a mergers and acquisitions factor, a management experience and qualifications factor, a litigation factor, an entity or non-entity coverage factor, a revenue and asset factor, and a specialty coverage factor. The method thereafter determines a public company modifier, which takes into account criteria and parameters unique to public companies.

The following description concerns exemplary methods for determining the public company modifier. In a preferred embodiment, the public company modifier is the product of a plurality of rating factors including a director and officer percent of stock factor, a stock performance factor, an offerings factor, a compliance with corporate governance standards factor, a market cap factor, a non-entity EPLI factor, and a boards and auditors factor. Each of these rating factors is discussed in turn below.

The director and officer percent of stock factor accounts for the affect on the overall risk of the percent of the public company's stock owned by its directors and officers. The following exemplary data table of rating factor values reflects the affect on the overall risk of the percent of the public company's stock owned by its directors and officer, which may be used to determine the director and officer percent of stock factor.

TABLE 22

| % of Stock Owned by D&O's | D&O % of Stock Factor |
|---|---|
| Greater than 50% | 0.70-0.80 |
| >35% to 50% | 0.80-0.85 |
| >20% to 35% | 0.85-0.90 |
| >15% to 20% | 0.90-0.95 |
| >10% to 15% | 0.95-1.00 |
| >5% to 10% | 1.00-1.05 |
| 5% or Less | 1.05-1.15 |

The stock performance factor accounts for the affect on the risk from the change in the price of the company's stock over the past year. The following exemplary data table provides stock performance factor values that reflect the affect on the risk from the change in the price of the Company's stock over the past year.

TABLE 23

| Stock Performance | Stock Performance Factor |
|---|---|
| Trading above year ago level | 0.75-0.90 |
| Trading at generally the same level as | 0.90-1.00 |
| year ago level | |
| Trading at 0% to 10% below year ago level | 1.00-1.05 |
| Trading at 10% to 20% below year ago level | 1.05-1.15 |
| Trading at 20% to 50% below year ago level | 1.15-1.25 |
| Trading at 50% to 75% below year ago level | 1.25-1.35 |
| Trading at over 75% below year ago level | 1.35-1.50 |

The offerings factor accounts for increased exposure facing directors and officers of companies that have recently completed an initial public offering (“IPO”) or are undergoing a follow-on or secondary equity offerings. The offering factor has three components: an offering size factor, a use of proceeds factor, and a “years since IPO” factor. The offering size factor reflects the size of such offerings. The use of proceeds factor reflects the use of offering proceeds. The years since IPO factor considers the amount of time since the IPO and reflects the understanding that higher risks are present in the years immediately following the IPO.

The offering factor is the product of the offering size factor, the use of proceeds factor, and the time since IPO factor. The following exemplary data table contains rating factor values that reflect the affect the offerings size, the use of offering proceeds, and the time since the IPO has on the risk. The offering factor is then calculated as the product of the offering size factor, the use of proceeds factor, and the years since IPO factor.

Offerings Factor=(Offering Size Factor×Use of Proceeds Factor)×Years Since IPO Factor

TABLE 24

| Offering Size | Offering Size |
|---|---|
| (% of Market Cap) | Factor* |
| Not Applicable | 1.00 |
| 10% of Market Cap and Under | 1.00-1.15 |
| >10% to 25% | 1.15-1.25 |
| >25% to 40% | 1.25-1.40 |
| >40% to 50% | 1.40-1.55 |
| >50% | 1.55-2.00 |
| | Use of Proceeds |
| Use of Proceeds | Factor* |
| Not Applicable | 1.00 |
| Working Capital | 0.95-1.05 |
| Debt Repayment | 1.15-1.25 |
| No Proceeds to Corporation | 1.15-1.25 |
| | Years Since IPO |
| Years Since IPO | Factor |
| 1 year or less | 1.50-2.00 |
| >1 to 2 years | 1.35-1.75 |
| >2 to 3 years | 1.25-1.55 |
| >3 to 4 years | 1.10-1.30 |
| Greater than 4 years | 1.00-1.15 |

The compliance with corporate governance standards factor takes into consideration the public company's adherence to corporate compliance standards. The adequacy of audit committee involvement in financial operations is considered, as well as a study into any accounting re-statements or other irregularities that may indicate nonconformity with compliance standards.

Considerations for determining the compliance with governance standards factor include the number of board positions held by officers, the qualifications of special committee members, the composition of the compensation and audit committees, the existence and enforcement of policies for corporate communications with outside groups and individual investors, the history of accounting restatements or expected restatements, and the general compliance with corporate management standards. The following exemplary data table provides a method to assign a rating factor value for the compliance with governance standards factor based on the degree of confidence or concern.

TABLE 25

| Degree of Concern/Confidence in the Public | |
|---|---|
| Company's (recognition of and) Compliance | |
| with Governance Standards | Rating Factor |
| Very Confident | 0.80-0.90 |
| Confident | 0.90-1.00 |
| Comfortable | 1.00 |
| Low Concern | 1.00-1.10 |
| Material Concern | 1.10-1.20 |
| High Concern | 1.20-1.35 |
| Very High to Severe Concern | 1.35-2.00 |

The market cap factor accounts for the total dollar value of all outstanding shares of the company, which is calculated by multiplying the number of shares and the current market price. The market cap is relevant because damages sought by shareholders asserting a securities claim generally follows the amount lost from a company's market capitalization over that designated time. Because the potential amount of damages resulting from claims for larger market cap companies is normally much greater, a higher degree of concern is typically assigned to larger companies.

It should be appreciated that the fluctuation in market capitalization over time dictates the amount of damages generally asserted in securities claims. Currently a 5-year time period is considered to reflect the applicable statute of limitations. Accordingly, the entire five year period, not only the current market capitalization, should be reviewed to ascertain the market cap exposure.

The following exemplary data table provides rating factor values that reflect the degree of concern regarding the total dollar value of all outstanding shares of the risk and fluctuation in market capitalization, which can be used to determine the market cap factor.

TABLE 26

| Degree of Concern/Confidence in the Public | |
|---|---|
| Company's Market Cap (i.e. Outstanding | |
| Shares v. Price) | Rating Factor |
| Very Confident | 0.80-0.90 |
| Confident | 0.90-1.00 |
| Comfortable | 1.00 |
| Low Concern | 1.00-1.10 |
| Material Concern | 1.10-1.20 |
| High Concern | 1.20-1.35 |
| Very High to Severe Concern | 1.35-2.00 |

The non-entity EPLI factor accounts for the affect on the overall director and officer risk as a result of the removal of non-entity EPLI coverage. The following exemplary data table is used to determine the non-entity EPLI factor.

TABLE 27

| Non-Entity EPLI Coverage included in Public | Non-Entity EPLI |
|---|---|
| Company form? | Factor |
| YES | 1.00 |
| NO | 0.85-1.00 |

The boards and auditors factor accounts for the effect a change in auditors, board of directors or key executives has on the underlying risk and the underwriter concern relating to such risk. The following exemplary data table is used to determine the boards and auditors factor.

TABLE 28

| | | | Yes/No |
|---|---|---|---|
| Consideration: | Yes | No | Answer |
| Has the Insured | High Concern: .20-.30 | (−.10)-0 | Ans1 |
| Company changed | Material Concern: .10-.20 | | |
| Auditors within | Low Concern: 0-.10 | | |
| the past year? | | | |
| Has the Company | High Concern: .20-.30 | (−.10)-0 | Ans2 |
| experienced changes | Material Concern: .10-.20 | | |
| to the Board of | Low Concern: 0-.10 | | |
| Directors or to its | | | |
| Key Executives over | | | |
| the past year? | | | |

| | |
|---|---|
| Boards & Auditors Factor | 1 + |
| | (Ans1 + |
| | Ans2) |

In addition to the above-mentioned criteria and parameters for determining the public company modifier, other factors are included in the public company modifier for public companies that are financial institutions. In one embodiment, the public company modifier for a financial institution may include a loan portfolio factor, a reserve adequacy factor, an investment portfolio factor, and a regulatory environment factor in one embodiment. In determining a value for each of the aforementioned factors, an underwriter first determines the level of confidence or concern with the subject matter of the factor.

The loan portfolio factor is only applicable to banks and reflects the type and quality of the loan portfolio. Diversification by industry, region and borrower can increase confidence while high concentration in a troubled industry, large single credits and a high percentage of sub-prime business can be causes for concern.

The reserve adequacy factor reflects whether the financial institution has set aside sufficient reserves to cover present and future losses such as loan defaults, insurance claims, poor investments, and disputed or unavailable reinsurance. The risk of surprise announcements of write-offs or a worsening of results is also evaluated.

The investment portfolio factor reflects the health of the institution's investment portfolio. For example, diversified, low risk, stable investments increase confidence. On the other hand, poor returns, and a high-risk investment concentration can each be a cause for concern.

The regulatory environment factor accounts for the exposure of the institution to regulatory scrutiny and enforcement. Strong internal controls can be important and simple services that increase compliance can build confidence.

For each of the loan portfolio factor, the reserve adequacy factor, the investment portfolio factor and the regulatory environment factor, the underwriter reviews the relevant considerations and reaches a level of confidence or concern. Based on that conclusion, each rating factor may be determined. The following exemplary data table may be used to determine each of the aforementioned financial institution factors.

TABLE 29

| Degree of Concern/Confidence | Rating Factor |
|---|---|
| Very Confident | 0.80-0.90 |
| Confident | 0.90-1.00 |
| Comfortable or Not Applicable | 1.00 |
| Low Concern | 1.00-1.15 |
| Material Concern | 1.15-1.25 |
| High Concern | 1.25-1.40 |

After determining the public company modifier, the method determines a resultant premium for directors and officers liability insurance for the public company account. The resultant premium is the product of the base premium, the limit/retention factor, the claims history factor, the financial condition factor, the industry factor, the years in operation factor, the mergers and acquisitions factor, the management experience and qualifications factor, the litigation factor, the entity or non-entity coverage factor, the revenue and asset factor, and the public company modifier.

In addition to the above-mentioned criteria and parameters that are applicable to all classes of companies, i.e., public, private, and not-for-profit, embodiments of the present disclosure includes criteria and parameters applicable to other types and classes of companies. For example, when determining a resultant premium for a private company, this embodiment first applies the criteria and parameters for all types and classes of companies. Next, the systems and methods may determine a private company modifier, which can take into account criteria and parameters unique to private companies. A private company modifier is the product of a set of rating factors where an exemplary list is shown in Table 30.

TABLE 30

| Private Company | |
|---|---|
| Modifier Composite | |
| Factors | Description |
| D&O Percent of | Factor accounts for percentage of stock |
| Private Stock Factor | owned by directors and officers of the |
| | company |
| ESOP Ownership Factor | Factor accounts for percentage of stock |
| | owned by an employee stock ownership plan |
| | and whether or not the plan is leveraged |
| Initial Public | Factor considers whether company plans to |
| Offering (IPO) Factor | go to public within the next year and, if so, |
| | the size of the offering and the use of the |
| | proceeds from the offering |
| Institution of | Factor considers whether the directors and |
| Appropriate Compliance/ | officers adequately adhere to governance |
| Governance Standards | standards and best practices to protect the |
| Factor | interests of the company's stakeholders |
| Public Debt Factor | Factor accounts for the placing of a private |
| | company's debt with public debtholders |
| Private Placement | Factor accounts for risk associated with |
| Factor | selling a portion of the company to qualified |
| | private investors |
| Non-entity EPLI Factor | Factor accounts for the affect on the overall |
| | risk of providing non-entity or co-defendant |
| | employment practices coverage |
| Boards and Auditors | Factor accounts for any concerns by a change |
| Factor | in the auditors, board or key executives |
| | within the past year. |

In another example, when determining a resultant premium for a not-for-profit organization, this embodiment first applies the criteria and parameters for all types and classes. In a next step, this embodiment determines a not-for-profit company modifier, which may take into account criteria and parameters unique to not-for-profit companies. A not-for-profit modifier is the product of a set of factors where an exemplary list is shown in Table 31.

TABLE 31

| Not-for-profit Modifier | |
|---|---|
| Composite Factors | Description |
| Tax Status Factor | Factor considers the taxable status of the |
| | not-for-profit organization under the U.S. |
| | Internal Revenue Code. |
| Percent of Revenues | Factor accounts for the percent of the |
| from Government | not-for-profit organization's revenue that |
| Sources Factor | comes from government sources. |
| Healthcare Institutions | Factor considers a number of aspects of a |
| Factor (Healthcare | healthcare institution that may pose a risk |
| Institutions only) | in the healthcare industry |
| Percent of Revenues from | Factor accounts for the percentage of the |
| Medicare/Medicaid Factor | not-for-profit organization's revenue |
| (Healthcare Institutions | received from Medicare/Medicaid. |
| only) | |
| Educational Institutions | Factor considers aspects of the education |
| Factor (Educational | institution that may pose a risk in an |
| Institutions only) | educational institution setting. |
| Association with Hospitals/ | Factor considers whether educational |
| Medical Schools Factor | institutions are associated with Hospitals |
| (Educational Institutions | and/or Medical Schools. |
| only) | |
| Boards Factor | Factor considers the election of board |
| | members and the conduct of the board of a |
| | not-for-profit organization. |
| Institution of Appropriate | Factor considers how adequately the not- |
| Compliance/Governance | for-profit organization adheres to the |
| Standards Factor | standards considered to be best practices |
| | for not-for-profit entities in protecting |
| | the interests of their stakeholders. |

Note that the foregoing risk factors are exemplary and that a person with ordinary skill in the art may create and apply other appropriate (e.g. different classes of entities, comply with government regulations, etc.) risk factors to determine a rate of insurance.

### Basic Rating Plans for Company Types and Classes

In another embodiment, the disclosure creates a basic rating plan for qualified private companies and not-for-profit organizations. This embodiment considers the company's total revenues, total assets, total liabilities, director and officer claims activity and history, positive net income or negative net income, and private placement amounts to determine whether the company qualifies for a basic rating plan. For example, a private company may be eligible for the basic rating plan if its total assets are less than $100M, its total liabilities are less than $100M, it has no claim activity or history, its negative income is no more than $5M, and its private placements are under $50M. It should be appreciated that any criteria known to those have ordinary skill in the art may be used to determine whether a private company is eligible for a basic rating plan.

When applying a basic rating plan, this embodiment considers underwriting criteria and parameters such as, for example, a base premium, a limit/retention factor, a private placements factor, an industry factor, a 3(b) securities offering factor, a net income factor, a years in business factor, a punitive damages factors, and a prior acts factor. The aforementioned criteria and parameters are exemplary; those skilled in the art will appreciate that other factors may be applied.

In another embodiment, the disclosure creates a basic rating plan for not-for-profit organizations. For example, the disclosure may consider the nature of the not-for-profit organizations operations. It should be appreciated that any criteria known to those who have ordinary skill in the art may be used to determine whether a not-for-profit organization is eligible for a basic rating plan.

When applying a basic rating plan, this embodiment considers underwriting criteria and parameters such as a base premium, a limit/retention factor, a nature of business factor, a claims history factor, a years in operation factor, a financial condition factor, a punitive damages factor, and a prior acts factor. The disclosure also considers a social welfare organization modifier when appropriate. The aforementioned criteria and parameters are exemplary; it should be appreciate that other factors known to those skilled in the art may be applied in addition to, or in the alternative to, those described herein. It should also be appreciated that an unavailable rating factor information rule may apply to one or more embodiments. For example, to the extent that the underwriter is unable to obtain sufficient information to permit a proper assessment and evaluation of the underwriting risk imposed by any applicable rating factor, the underwriter can apply a neutral factor for such factor. The corresponding underwriter file information can document that sufficient rating information could not be obtained from the insured or other available sources.

### Determining a Rate of Insurance Using Factors

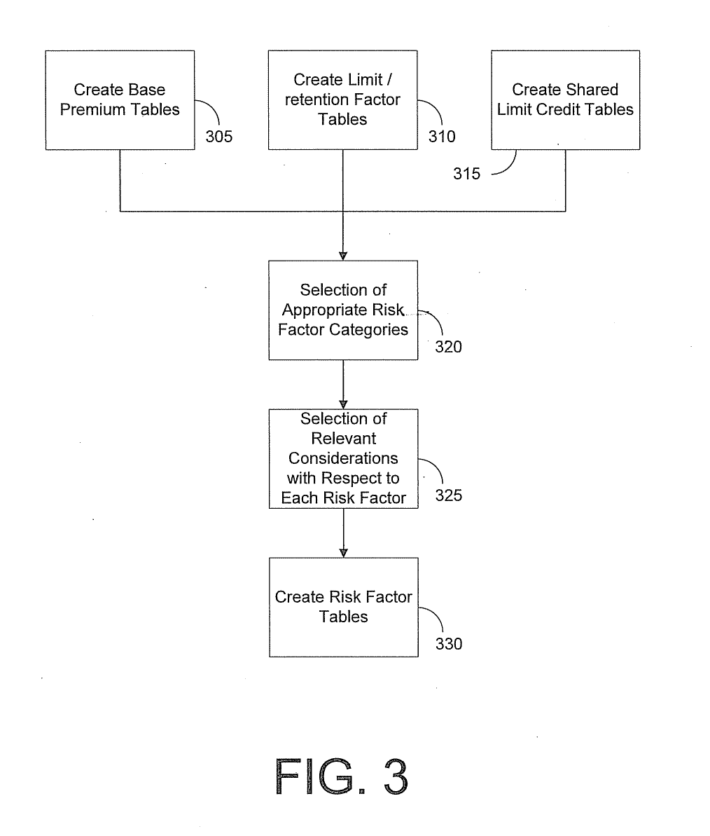

The following description describes an exemplary embodiment using the previously discussed methods of determining base premiums, marginal rates, limit/retention factors, shared limit credits, and risk factors. FIG. 3 is a flow diagram that illustrates an exemplary method of creating a rate plan according to an aspect of the disclosure. The steps illustrated in the flow diagram in FIG. 3 may be implemented by an insurance company 125 to create a plan to calculate appropriate insurance rates for director and officer liability using one or more software application 132 in a computer network system (130-135). At a step 305, an insurance company creates base premium rate tables (with marginal rates) for public, private, and not-for-profit entities. Each base premium rate table takes into account the value of the assets of the client entity and the industry in which it operates. Further, at a step 310, an insurance company creates limit/retention factor tables for each company type. In addition, at a step 315, an insurance company creates shared limit credit tables for all company types. Shared limit credits apply when a single limit of liability is shared among two or more coverage types. Each coverage may be subject to a distinct sub-limit. The values used in the tables created in steps 305-315 are derived through the application of actuarial science techniques using software applications and stored in one or more databases 135. At a next step 320, appropriate risk factor categories are selected. Risk factors may be applied to all types of organizations or only to certain types and/or certain industries. At a next step 325, relevant considerations are selected with respect to each risk factor. At a next step 330, risk factor tables are created to determine each risk factor value based on objective criteria and/or underwriter's comfort and concern level after review of relevant consideration. The table created in step 330 using software applications and stored in one or more databases.

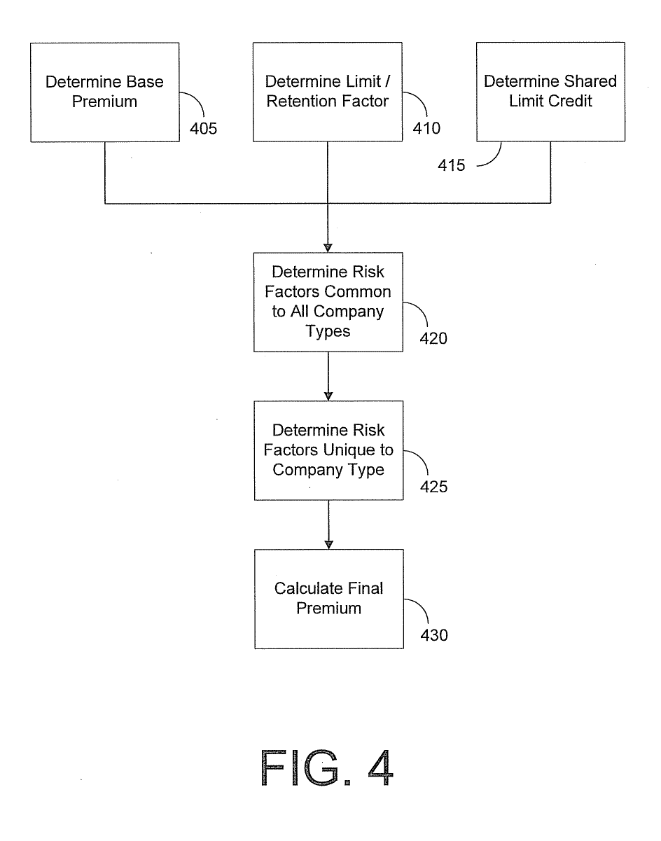

FIG. 4 is a flow diagram that illustrates an exemplary method of determining a rate in accordance to an aspect of the disclosure. At steps 405, 410, and 415, an underwriter using a rater spreadsheet application determines the base premium, limit/retention factor, and shared limit credit for a particular coverage, respectively. The rater spreadsheet application accesses one or more databases to retrieve the appropriate base premium, limit/retention factor, and shared limit credit values from the tables created in steps 305-315. For example, if the company is a not-for-profit organization, then the base premium is obtained from the base premium table for not-for-profit organizations. In another example, if there are no sub-limits in the shared limit coverage, then the shared limit credit value is accessed from a shared limit credit with no sub-limit table (Table 4). At a next step 420 and 425, an underwriter uses a rater spreadsheet application to determine the value of risk factors common to all company types, as well as risk factors unique to the company type and/or industry that is being underwritten. At a next step 430, the rater spreadsheet application calculates the resultant premium as the product of the base premium, limit/retention factor, shared limit credit, common risk factors, and company type-specific risk factors.

A rater spreadsheet application implements a set of rating modules corresponding to the set of risk factors appropriate for the type of entity and industry. The implementation of each rating module includes determining the mode, level, and value for a risk factor. Selecting a mode determines the plurality of levels available in each rating module and the limitations on the range of factor values at each level. Selecting a level provides a range of factor values. A mode is selected based on a basic risk assessment of the entity (company) and applicable state regulations. Exemplary modes may be standard, extended, and restricted. A standard mode has the levels shown in the previous risk factor tables (e.g., claims frequency in Table 13) and meets the regulatory requirements of most states. The standard levels are typically confident, comfortable, low concern, material concern, high concern, very high concern (See FIG. 6B (620)). An extended mode contains all the levels in standard mode with addition of extremely confident and extreme concern (See FIG. 6B (622)). Restricted mode contains the same levels as standard mode but allows only one factor value for each level (to comply with state regulations in certain states). The mode remains constant for all risk factors and rating modules for each calculation of a resultant premium.

FIGS. 6A-C are exemplary spreadsheet implementations of a rating module aspect of the disclosure. FIG. 6A shows an exemplary rating module for a claim severity factor or ratable 604. This rating module is part of the rater spreadsheet application used in calculating the D&O premium for an insured client. A rating mode 602 determines the levels of comfort or concern available to an underwriter and the range of values available at each level for the risk factor.

An underwriter or insurance rating professional may choose the rating mode from a drop down list 612. Note that drop down lists are also called validation lists. When selecting a standard rating mode, drop down list 606 allows an underwriter to select a level from the list shown in table 620. Once a level is chosen, for example “Very High Concern”, then an underwriter may choose a factor for the level from drop down list 608. The factor's range of value is shown in table 628 and available in drop down list 608. Once a factor is chosen, it may be used in determining the resultant premium. If an underwriter selects a factor that is not valid for the level selected, or a level that is not valid for the mode, the “Reset” cell in the rater spreadsheet 610 will display “Reset” and a resultant premium cannot be calculated.

A table 614 lists the index number for each of the rating modes for the risk factor. The index numbers may vary by risk factor. For example, not every risk factor has the selected extended rating mode. Table 616 defines the allowable range of values for a risk factor for a separate level. Based on the mode selected. Table 618 collects the relevant inputs (i.e. levels and their associated factors) from one of the tables (620-626).

Table 628 is a data validation list for the allowable factors for the selected level. It is constructed by the spreadsheet application based on the mode and level selected using the data in the tables for each rating mode (618-624). The spreadsheet constructs table 628 by reading the minimum value and the “step” from table 616 and using the index table in the left column of table 628, calculates the factor value. An advantage is the implementation of the rater spreadsheet computer application is that by using validation lists in a single location and changing their values, it eliminates the need for macro functions.

Using validation lists are an advantage over using macros for three reasons. First, validation lists provide an underwriter with transparency in the calculation of the rate. Alternatively, macros require decompiling that may need debugging and makes the calculation opaque from the underwriter's perspective. Second, validation lists provide a better flow of control, prevents security issues and is less likely to crashing than implementing macros. Third, the functional implementation of validation lists causes less confusion than dialog boxes and other accessory functions that are needed to implement macros.

Preceding rating modules have been implemented and their risk values have been multiplied to calculate the “premium before” value in Table 630. The value of the risk factor for the rating module in FIG. 6 is multiplied to the “premium before” value to calculate the “premium after” value. The “premium before” is carried forward from the previous rating modules and the “premium after” value is used as the “premium before” value in the subsequent rating module. Table 632 displays any errors in the calculation using the rating module. For example, if the level or factor selected is not one allowed by the rating mode or level, respectively, then an error is indicated by the word “TRUE” and the Reset flag is enabled in Table 610.

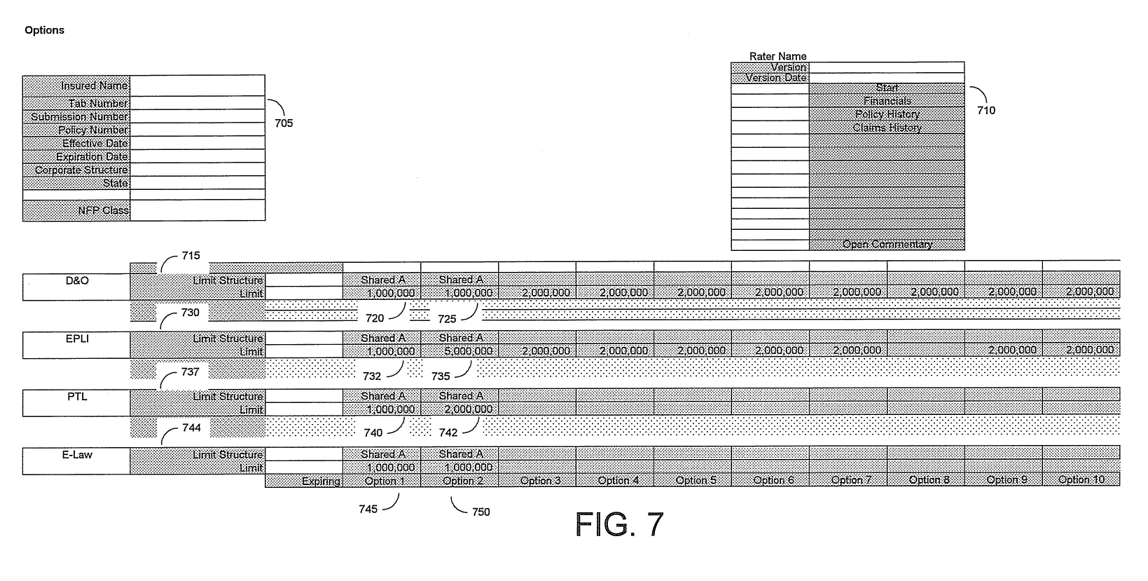

FIG. 7 is an exemplary spreadsheet implementation of a shared limit credit calculation aspect of the disclosure. FIG. 7 shows the different options or insurance coverage packages that may be used in the shared limit credit calculation. Table 705 provides the insured and policy information. Table 715 shows the limit structure for D&O liability for two different options. For each option the limit structure is of type Shared A and the limit of liability for the coverage is $1 million (720, 725). Table 730 shows the limit structure for EPLI coverage. It is also of limit structure type Shared A, but in option 1 (732) the limit is $1 million and in option 2 (735) the limit is $5 million. Table 737 shows the limit structure for Pension coverage. It is also of limit structure type Shared A, but in option 1 (740) the limit is $1 million and in option 2 (742) the limit is $2 million. Table 744 shows the limit structure for Lawyer coverage. It is also of limit structure type Shared A, but in option 1 (745) and option 2 (750) the limit is $1 million. All of the coverages in FIG. 7 have the same limit structure and thus fall under the same shared limit. Therefore, a shared limit credit is calculated.

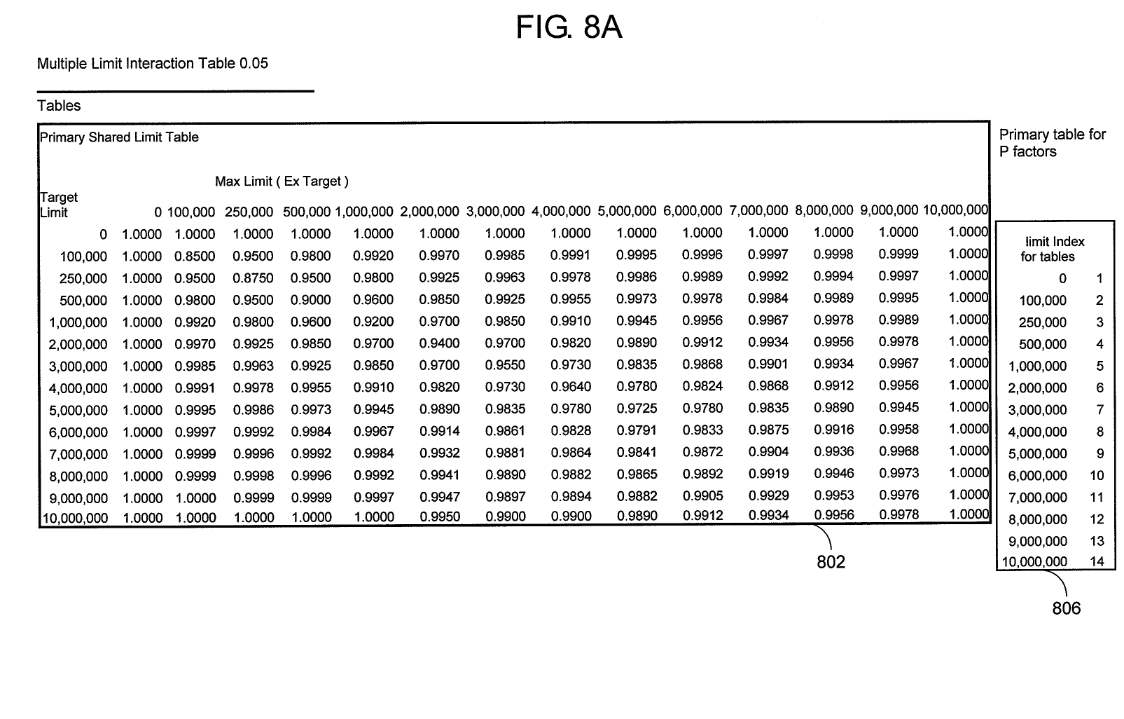

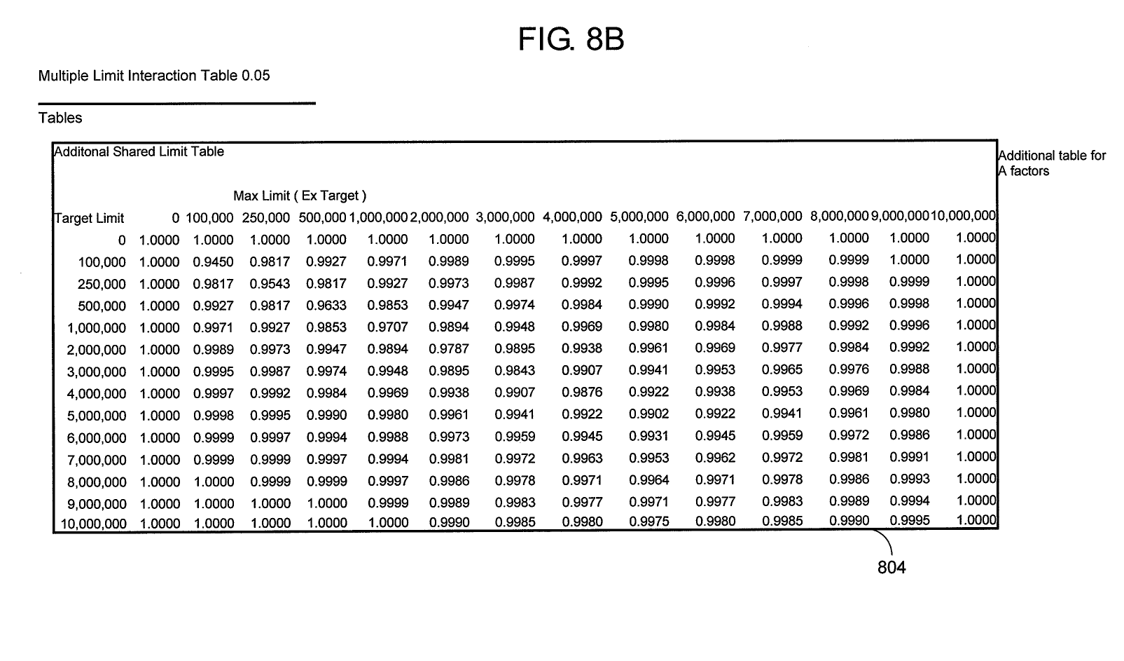

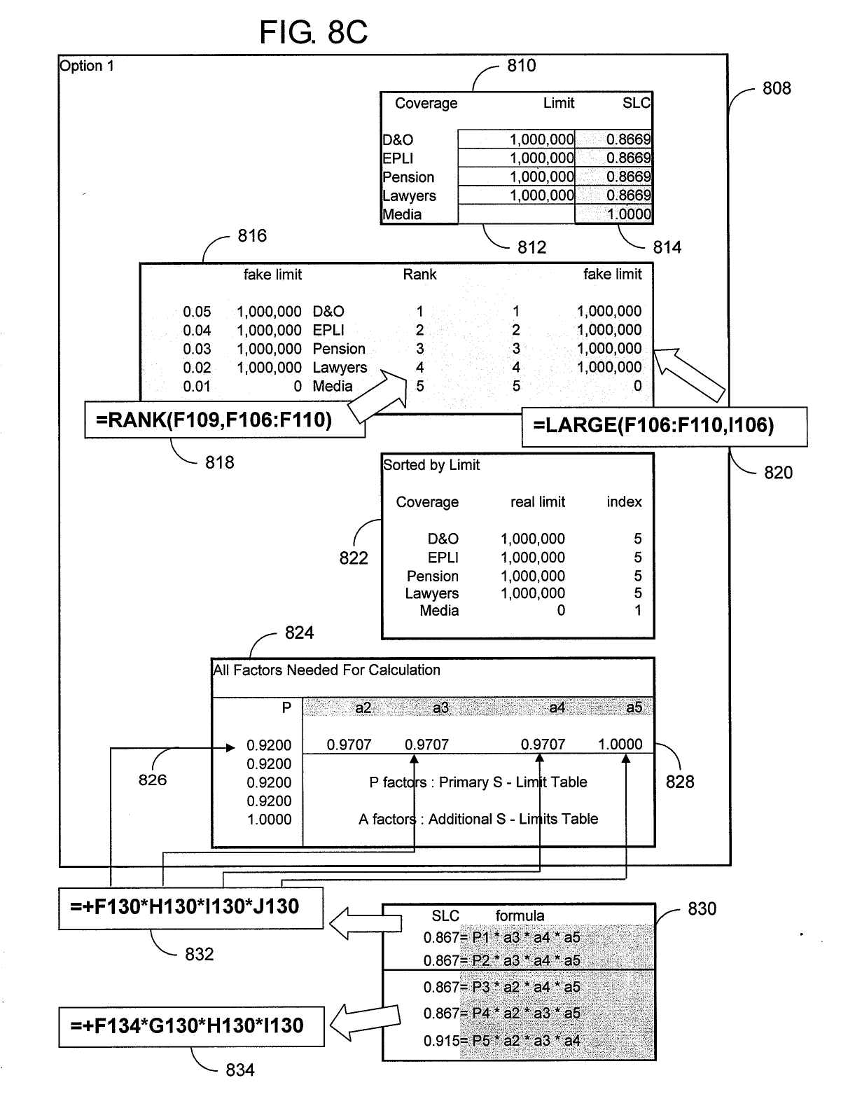

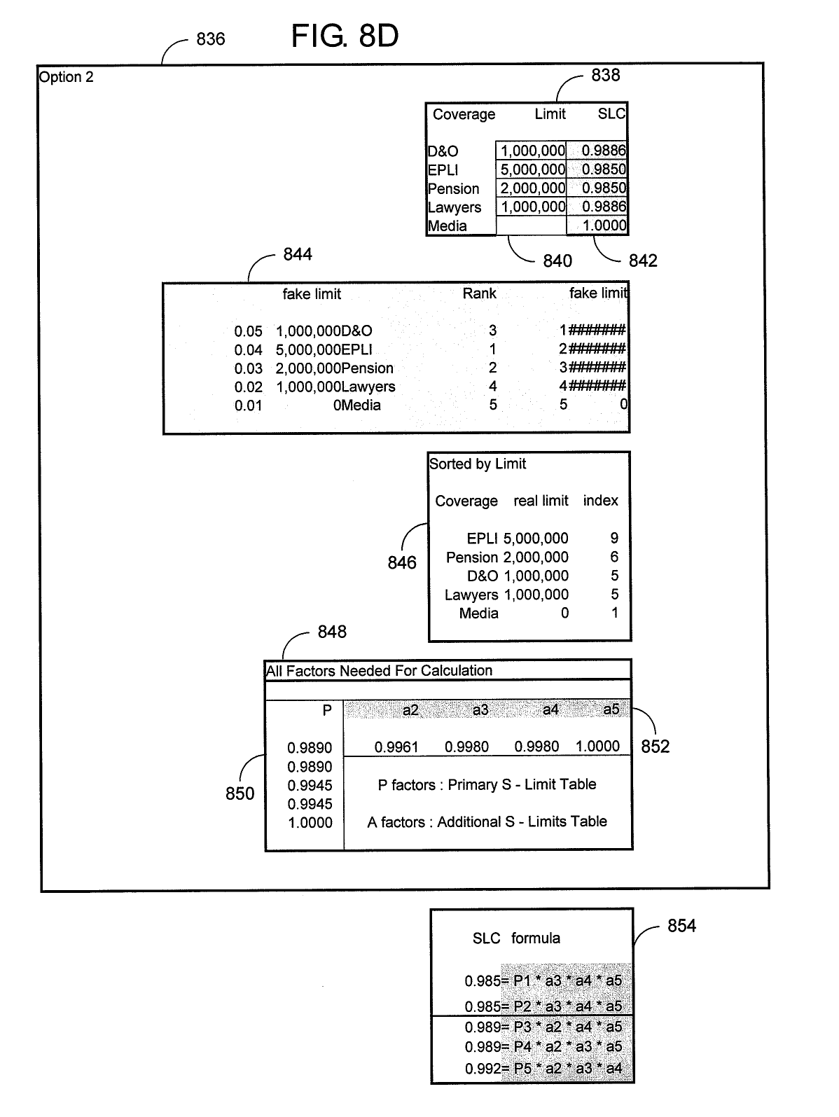

FIGS. 8A-D are another exemplary spreadsheet implementations of a shared limit credit calculation aspect of the disclosure. Table 802 is the primary shared limit table and effectively defines the total shared limit credit for two coverages. It also defines the first value used in calculating a shared limit credits for multiple coverages. Table 804 is the additional shared limit table and provides the additional values when there are more than two coverages. The Option 2 from FIG. 7, shown in Table 836 is an illustrative example for calculating shared limit credits for coverages with sub-limits. Table 838 shows the limit for each coverage in the package (taken from the table in FIG. 7) 840 and the shared limit credit (SLC) calculated using the spreadsheet application 842. Table 844 manipulates the data such that it can rank each coverage from the largest limit to the smallest limit. Table 846 sorts the coverages in descending order by limit size. Table 848 provides the primary 850 and additional SLC 852 for every combination of coverages. Table 854 provides the overall SLC for each coverage and is placed in table 838 in column 842. The first SLC listed in Table 854 is for the EPLI coverage and is 0.9851. EPLI SLC is calculated as follows.

The EPLI coverage is $5 million dollars and the coverage with the next highest limit is the Pension coverage with a sub-limit of $2 million. The primary shared limit credit is determined using the limit of these two coverages. The target limit is $5 million (the limit of the EPLI coverage) and the maximum limit is $2 million (the sub-limit of the Pension coverage). Looking up the primary SLC value in Table 802 using the target and maximum limits results in a value of 0.989. Additional shared limit credits are found in the following manner. The D&O coverage has a $1 million sub-limit. Thus, the additional SLC for EPLI due to sharing with D&O coverage is found by looking up the value in Table 804 for a target limit of $5 million (EPLI limit) and a maximum limit of $1 million (D&O sub-limit). The resulting additional SLC is 0.998. The additional SLC for EPLI due to Lawyers coverage is found to be the same value (0.998) because the Lawyers coverage has the same sub-limit of $1 million as the D$O sublimit. Therefore, the overall SLC for the EPLI coverage is found to be the product of the primary SLC and the two additional SLCs for a value of 0.985.

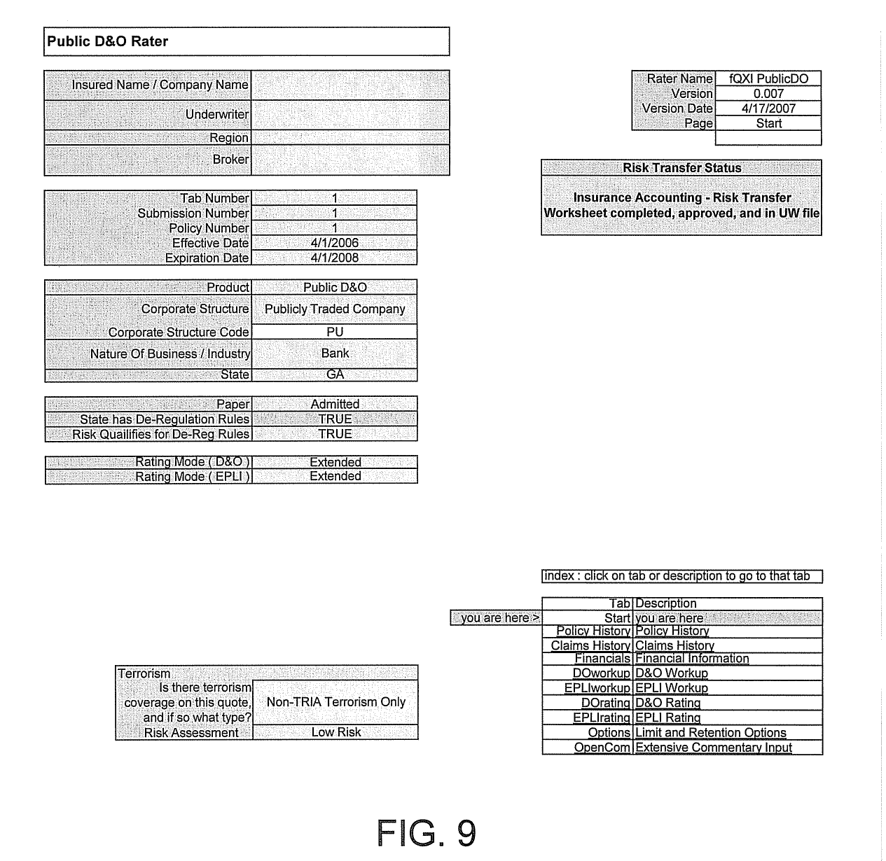

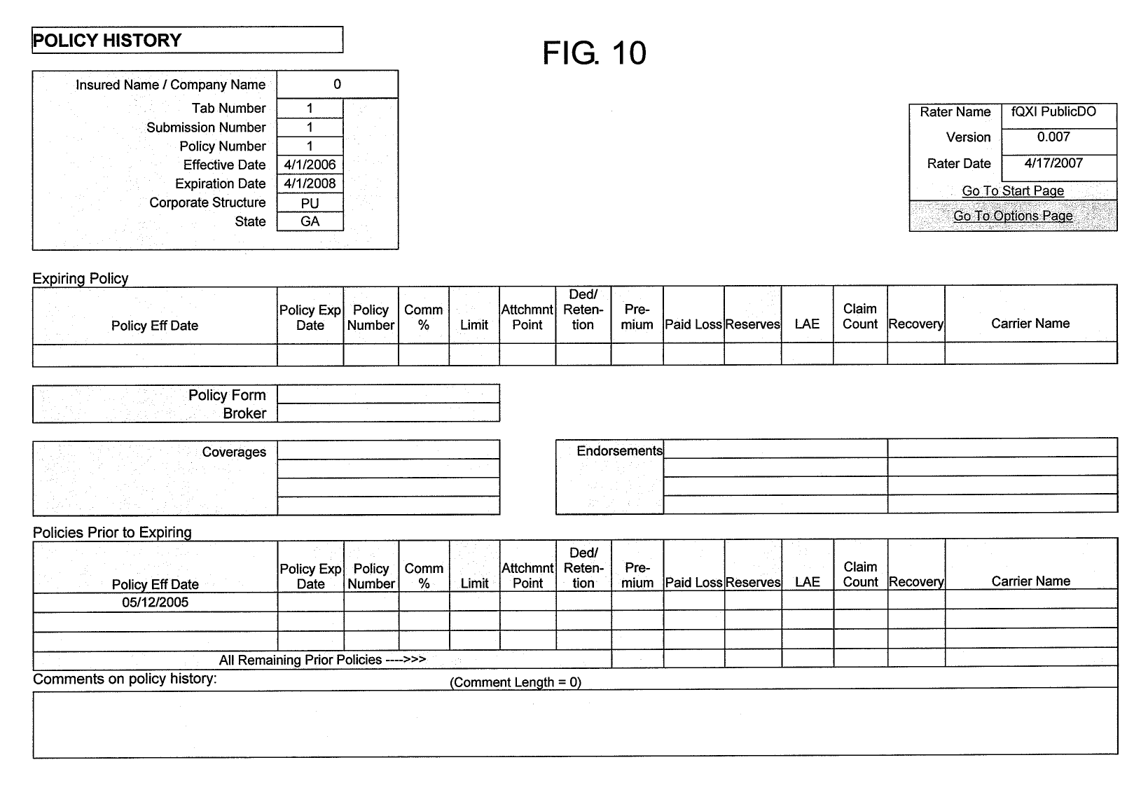

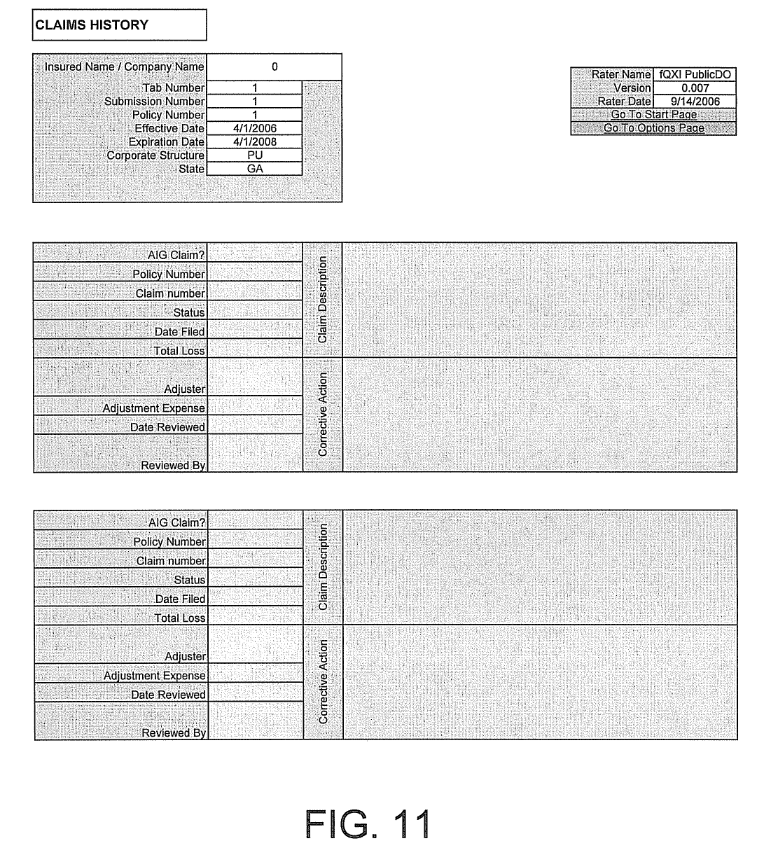

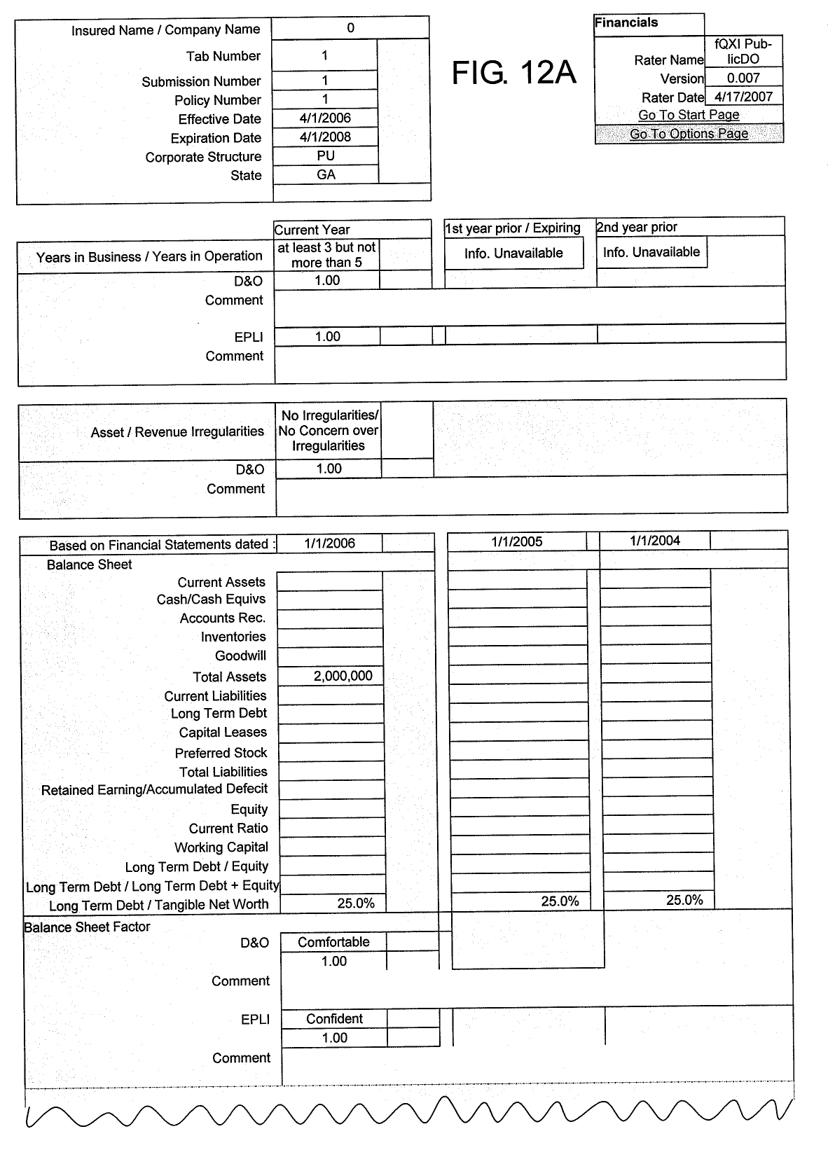

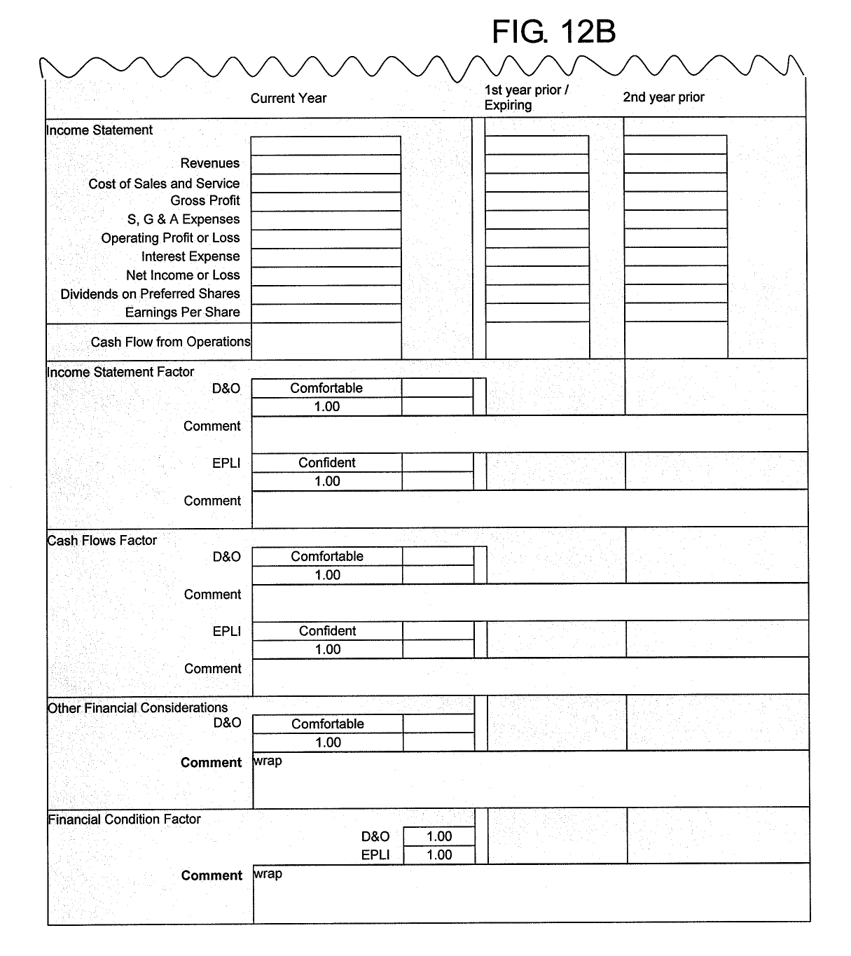

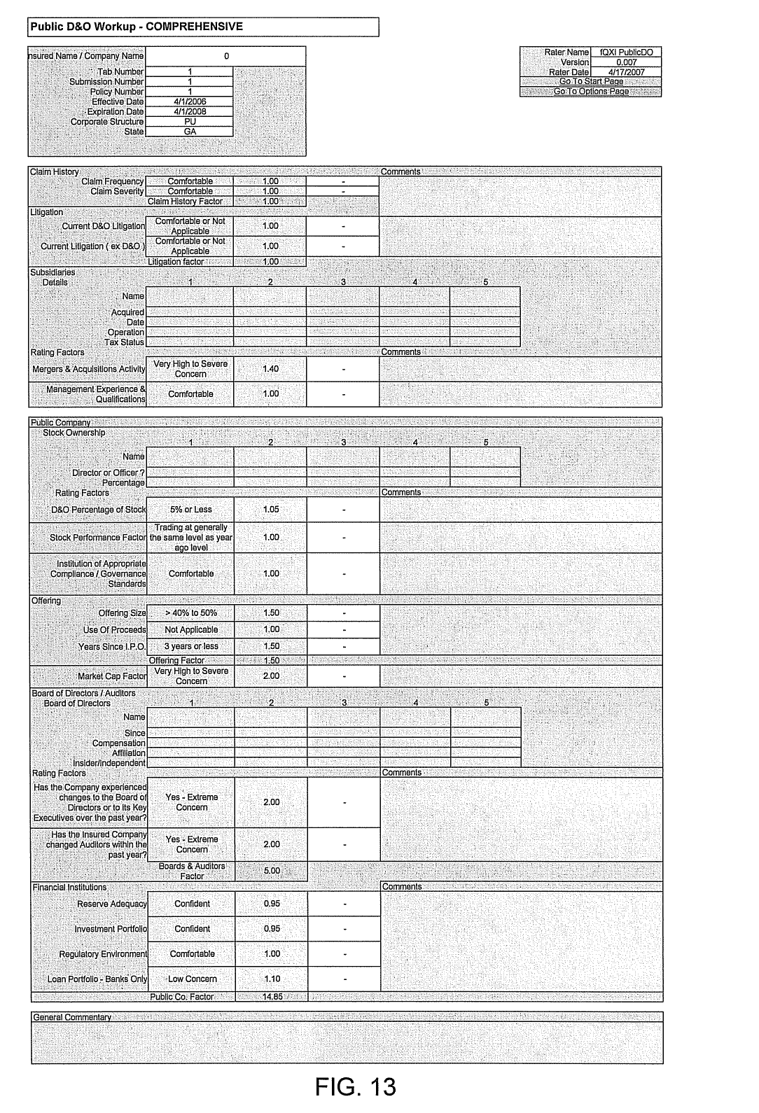

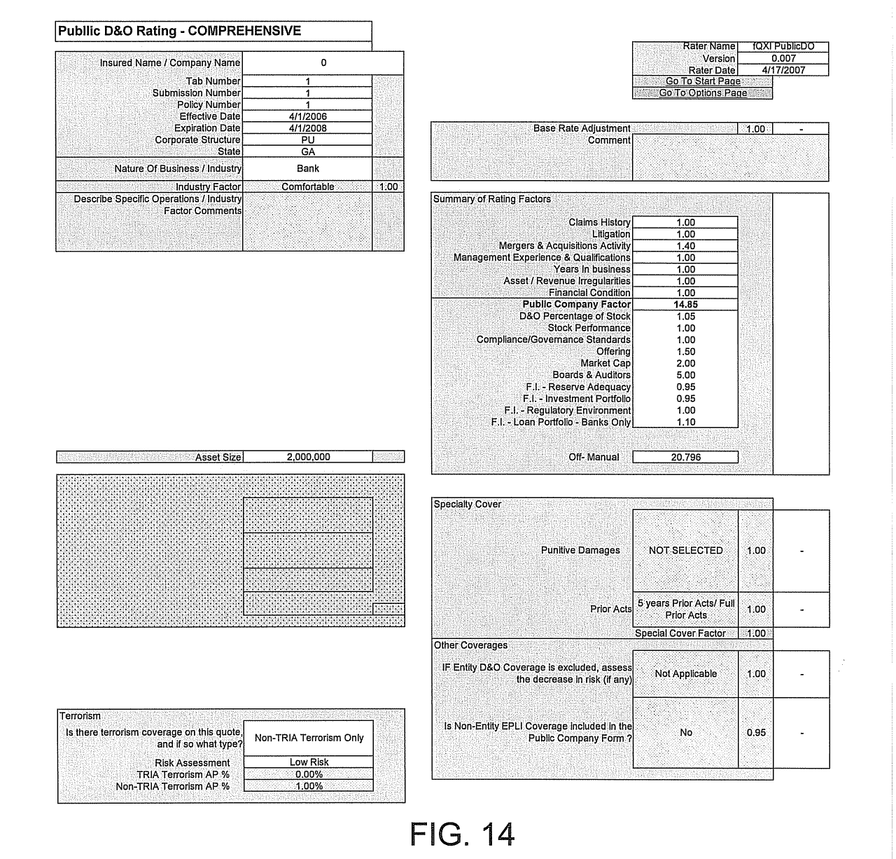

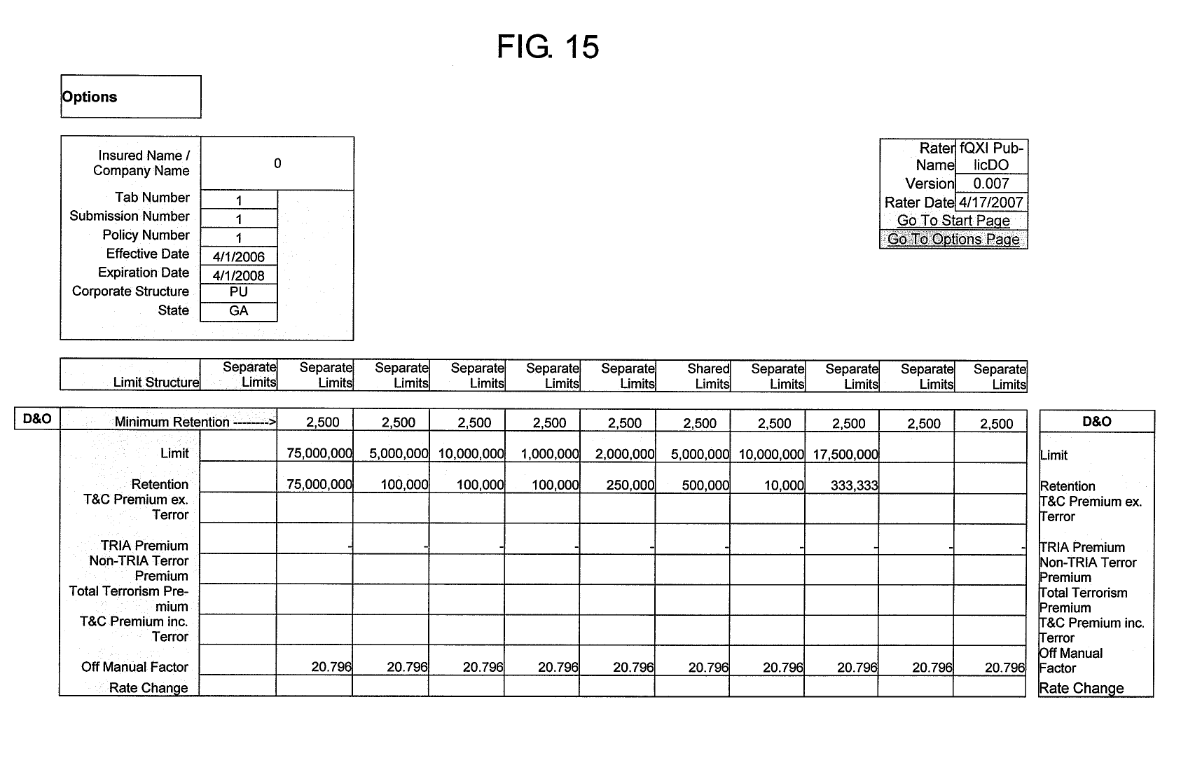

FIGS. 9-15 are exemplary worksheets that may comprise a public rater spreadsheet application. FIG. 9 is an exemplary Start sheet of a rater spreadsheet application. It allows an underwriter to enter basic information about the prospective insured client and policy. Further, the underwriter selects the rating mode (standard, extended, or restricted) that will apply to all rating modules. In addition, it provides navigation tools for the underwriter to select different spreadsheets within the applications. FIG. 10 allows the underwriter to enter the policy history into the rater spreadsheet application. FIG. 11 provides the insured client's claims history to the rater spreadsheet application. FIGS. 12A-12B are exemplary financial sheets that allows the underwriter to enter the insured client's financial information and determine the applicable financial risk factors (e.g. balance sheet factor, income statement factor, etc,) based on such financial information. FIG. 13 is an exemplary work up sheet within the rater spreadsheet application that allows an underwriter to work up a comprehensive rating plan for D&O liability. The sheet includes the applicable risk factors (claims history factor, litigation factor, etc.) for the insured client based on the information entered on this sheet or the sheets depicted in FIGS. 9-12B. When an underwriter selects a risk factor level and value in the spreadsheets depicted in FIGS. 12A-13, the rater spreadsheet application implements rating modules (similar to the exemplary rating modules shown in FIGS. 6A-C for each risk factor to validate the underwriter's selection and facilitate the calculation of the resultant premium. FIG. 14 is an exemplary rating sheet that provides a summary of factors and the rating for D&O coverage. FIG. 15 is an exemplary options sheet that shows the different options with respect to D&O coverage and the resultant premiums.

Aspects of the disclosure may be characterized as having different embodiments that include an offline and online component. An exemplary offline embodiment of the disclosure may be described as a rater spreadsheet software application where an insurance company representative 150 completes a rater spreadsheet application that includes data pertaining to the insured client. This rater application may be stored in a local computer 145. The insurance company representative 150 may then decide on a policy and premium to offer the insured in an internally and externally compliant manner. These results are entered into a production computer system (130-135) for booking and policy issuance.

An online embodiment provides a rater spreadsheet software application 132 to an insurance company representative with added functionality such that the rater spreadsheet application 132 is a directly executable within the productions system (130-135). Consequently, the results are automatically entered into the system for booking and issuance. All the individual data elements within the completed rater spreadsheet application are stored in the online database 130 to be recalled reviewed queried as needed.

To convert an offline implementation embodiment to an online implementation embodiment, two worksheet components are added to the rater spreadsheet application 132, one for collecting the input from the production system and one for passing the information back to the production system (130-135). Because a given rater spreadsheet application 132 is completely defined by its inputs, when an offline rater and online rater spreadsheet application 132 are completed with the same information, they will provide the same results. This creates a significant reduction in data storage because insurance companies do not have to store the completed rater spreadsheet applications for each insured client. Once the data has been calculated and passed back into the production system (130-135), the rater spreadsheet application may be discarded. When a system user re-invokes the rater application 132, the data is loaded back into a “new” rater spreadsheet application from a database 130 such that is identical to the one that existed previously. Storing the data points in the database 130 instead of thousands of individual rater spreadsheet applications creates a tremendous savings in data storage. In addition, the rating elements of each rater spreadsheet application are fully searchable to provide a more efficient underwriting process.

Accordingly, a method and system for determining insurance rates for directors and officers liability insurance has been disclosed. Those skilled in the art will appreciate that variations to the above disclosure may be employed without departing from the spirit and scope of the teachings herein. The scope of protection, therefore, should not be limited to the above currently preferred embodiments. Instead, the invention is intended to extend to the appended claimed subject matter, which is also made part of this disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-49. (canceled)

50. A method of calculating a shared limit credit implemented by a rater spreadsheet application executing on an insurance computer network system, the method comprising:
selecting, by the rater spreadsheet application stored on a non-transitory computer readable medium of the insurance computer network system, a plurality of insurance coverages comprising at least one of an insurance policy and a package of policies and sharing an aggregate limit of liability, wherein the plurality of insurance coverages comprises a first insurance coverage, a second insurance coverage, and a third insurance coverage;
accessing, by the insurance computer network system via the rater spreadsheet application, a primary shared limit credit value based on a target limit and a first maximum limit, wherein the target limit is a sub-limit of the first insurance coverage and the first maximum limit is a sub-limit of the second insurance coverage and the second insurance coverage is the coverage with the highest sub-limit of liability among the plurality of insurance coverages exclusive of the first insurance coverage;
accessing, by the insurance computer network system via the rater spreadsheet application, an additional shared limit credit value based on the first target limit and a second maximum limit, wherein the second maximum limit is the sub-limit of the third insurance coverage and the third insurance coverage is the coverage with the highest sub-limit of liability among the plurality of insurance coverages exclusive of the first insurance coverage and the second insurance coverage; and
calculating, by the insurance computer network system via the rater spreadsheet application, the shared limit credit for the first insurance coverage, wherein the calculation of the shared limit credit for the first insurance coverage comprises multiplying the primary shared limit credit value by the additional shared limit credit value.

51. The method of claim 50 wherein the plurality of insurance coverages further comprises at least one additional insurance coverage, the method further comprising:
accessing, by the rater spreadsheet application, an additional shared limit credit value corresponding to each additional insurance coverage; and
wherein the calculation of the shared limit credit for the first insurance coverage further comprises multiplying the primary shared limit credit by each additional shared limit credit value corresponding to each additional insurance coverage.

52. The method according to claim 50, wherein the primary shared limit value and the additional shared limit credit value are based on at least one of shared limit credits with no sub-limits between two insurance coverages, shared limit credits with no sub-limits between multiple coverages, primary shared limit credits based on a target limit and a maximum limit, and additional shared limit credits based on a target limit and a maximum limit.

53. The method according to claim 50, wherein the primary shared limit credit value and the additional shared limit credit value are stored in a plurality of databases that are part of the insurance computer network system.

54. The method according to claim 50, wherein the rater spreadsheet application comprises a plurality of data input worksheets, base premium values, limit/retention factor values, shared limit credit values, and rating modules.

55. The method according to claim 54, wherein the plurality of rating modules correspond to a plurality of risk factors, each comprising of a plurality of modes, a plurality of levels, and a plurality of factor values.

56. The method according to claim 55, wherein a mode is selected from a group consisting of standard, extended, and restricted.

57. The method according to claim 55, wherein a level is selected from a group consisting of extremely confident, confident, comfortable, low concern, material concern, high concern, very high concern, extreme concern, and information unavailable.

58. The method according to claim 55, wherein a factor value is selected from a range from a minimum value to a maximum value with incremental steps.

59. The method according to claim 55, wherein the number of levels available for a risk factor category is based on which mode is selected.

60. The method according to claim 58, wherein the minimum value, maximum value, and incremental steps of a factor are based on which level is selected.
